(19) United States
(12) Patent Application Publication
(10) Pub. No.: US 2005/0191605 A1
(43) Pub. Date: Sep. 1, 2005

(54) Method and apparatus for improving math or other educational skills

(76) Inventors: Hoanganh T.(HT) Nguyen, Saratoga, CA (US); Max Bell, Chicago, IL (US)

Correspondence Address: James F. Goedken;Bell, Boyd & Lloyd LLC, P.O. Box 1135, Chicago, IL, 60690-1135, US

(21) Appl. No.: 11/049,439

(22) Filed: Feb. 1, 2005

Related U.S. Application Data
(63) Continuation of application No. 10/335,118, filed on Dec. 31, 2002.

(51) Int. Cl. G09B 19/02

(52) U.S. Cl. 434/188

(57) ABSTRACT

A method and apparatus for intelligently tutoring a student to improve math or other skills is provided. The method and apparatus present groups of problems to a student in a sequential manner, and award points to the student when the student enters a correct response. Statistics regarding the student's performance are recorded and may be viewed in a variety of selectable formats so that parents, teachers, and other interested parties can track the students progress. The student's performance is analyzed, and the level of difficulty of problems being presented is controlled in order to challenge a student to improve educational skills, without over or under burdening the student.

### RELATED APPLICATIONS

This application is a continuation-in-part and claims priority to U.S. patent application Ser. No. 10/335,118 filed on Dec. 31, 2002.

### BACKGROUND

The present invention relates to a method and apparatus for improving a student's abilities in math or other subjects and other educational skills by intelligently tutoring the student.

A strong education is an important component of a successful and productive member of society. In addition, educational achievement is constantly measured and used as a benchmark for schools, teachers and individual students. Accordingly, many organizations and groups including state, local and federal governments, teachers and parents are constantly striving to find new ways to improve and gauge a student's educational progress.

Mathematical competence is vital in today's information and technology driven economy. Math skills along with reading are often targeted for special attention by school districts attempting to prepare their students for success in this environment. While it is desired that all students will excel in learning math, it is a well-known fact that students' abilities vary, and that their skills develop at differing paces. Therefore, it is important to allow students to work at their own pace, even if that pace is slower or faster than the student's peers in his or her math class. A student may feel discouraged or overwhelmed if the pace at which they are learning is too fast or simply bored if the pace is too slow. Therefore, it is desirable to provide a student with an environment and method of learning where progress is encouraged without discouraging or overwhelming the student and maintaining the student's interest.

The present disclosure relates to a method and apparatus for controlling the level of difficulty of problems being presented to a student. Because it is important to allow students to work at their own pace, it is desirable to provide students with an environment and method of learning where the level of difficulty of the problems being presented to the students is appropriate to the student's ability. Furthermore, it is desirable that the level of difficulty of the problems presented to the student change over time to reflect changes in the student's abilities over time. For example, as a student progresses, he or she becomes more confident and is able to handle more difficult problems. In this case, the difficulty of the problems presented to the student should be increased to keep pace with the student's advancing abilities. Similarly, if there is a gap in the student's studies, the student may be in need of a refresher. In this case, the difficulty level of the problems presented to the student should be eased to allow the student to practice on more familiar problems before moving back into more difficult problems appropriate for his or her level. Accordingly, it is desirable to generate and retain data related to the student's performance in order to determine when the level of difficulty should be changed.

In addition, in an educational setting it is often necessary to evaluate a student's progress in mathematics and other subjects and classes. Many students receive letter grades or evaluations in their various classes, but standard grades and evaluations do not always accurately reflect a student's progress or indicate areas where a student needs improvement. Therefore, it is desirable to track and monitor a student's progress and to identify, for example, problem areas or areas in which a student needs improvement.

### SUMMARY

An embodiment of the present invention may be employed to improve a student's math skills, or other educational skills, and to track and monitor the student's progress. Another embodiment of the present invention may be employed to control the difficulty of problems presented to a student to encourage learning without over or under burdening the student abilities.

An embodiment of the present disclosure provides a method and apparatus for improving a student's performance via intelligent tutoring of the student. An embodiment of the present invention facilitates improvement of a student's math or other skills, and enables a teacher or parent to supervise or track the student's progress. Another embodiment of the present disclosure is that it compiles an ongoing record of the student's progress that can be viewed and sorted by a number of statistical categories. In addition, in a further embodiment, it allows the student to progress to more or less advanced problems based upon the record of the students performance.

According to an embodiment of the present invention, a method for improving a student's math performance is provided. The embodiment includes displaying a first math problem, receiving a response to the problem from the student and determining whether the student's response is correct. If the student's response is incorrect, an indication is displayed that the response is incorrect and the student is allowed to continually provide answers until the correct response is received. Thereafter, the student is awarded a predetermined number of points when it is determined that the student has provided a correct response. The predetermined number of points are added to a running total of points awarded to the student.

The inventive method then sequentially displays additional math problems to the student upon receiving a correct response to each previously displayed math problem and continually receives responses from and awards points to the student for the additional math problems as with the first math problem. Thus, the method presents practice problems to the student in a game-like format, with the running point total serving as the students score. In one embodiment, there are not time limits on the problems, and the student may practice at his or her own pace. In alternative embodiments, time limits may be imposed on individual problems or an entire problem session. One feature of this embodiment is that statistics are maintained regarding the student's performance on the problems and used with parameters to determine when a level of difficulty should be changed.

In one embodiment, the performance statistics include the number of responses received from the student for each problem before a correct response is received. In another embodiment, the statistics include an amount of time required by the student to respond correctly to each problem.

An embodiment of the present disclosure provides that the level of difficulty of the problems displayed may be selected or changed. Accordingly, in one embodiment the parameters are preset or established that are indicative of the level of difficulty selected for each problem. The parameters may include the number of digits to be included in the first operand of the problems, and may also include the number of digits to be included in the second operand of the problems. In yet another embodiment, one or more mathematical operators are selected and employed in the displayed math problems. One additional embodiment of the present disclosure includes displaying the performance statistics in a number of selectable formats. In yet another embodiment, the level of difficulty is automatically changed based upon statistics as to how the student is performing. Additionally, the present disclosure includes controlling the changing of the level of difficulty based upon an analysis of the student's performance.

According to another embodiment of the present disclosure, an apparatus for interactively improving a student's math skills and tracking the student's progress is provided. The apparatus includes a display adapted to display math problems, an input interface for receiving the student's responses to the math problems displayed on the display, and a processor. The processor is adapted to generate the math problems displayed on the display, evaluate the student's responses in order to determine whether the student has correctly answered the problems, to award points to the student when the student correctly answers a problem. The apparatus further includes a memory for storing operating parameters as well as statistics related to the student's performance in answering the problems. The processor is further capable to evaluate statistics related to the student's responses in order to determine whether to change the level of difficulty of the problems being presented to the student.

In one embodiment, the apparatus is a personal computer or a server. In an alternative embodiment, the apparatus is a handheld device, for example, a programmable personal digital assistant. The handheld device of the present disclosure is configured to transfer the statistics stored in the memory to another device such as a personal computer, a server or a computer network via a synchronization function performed between the handheld device and the other device.

In an embodiment of the present disclosure the processor can be adapted to parse the statistics and to cause the display to display the statistics in a graphical manner. In a further embodiment the processor can be adapted to evaluate the statistics and to change the level of difficulty of the problems being presented. In one embodiment, the statistics are displayed as a 3-dimensional graph. The 3-dimensional graph preferably includes a first axis and a second axis which relate to the complexity of the problems addressed by the student, and a third axis which relates to the student's performance on the problems. For instance, the first axis could represent a number of digits in a first operand of the problems addressed by the student, and the second axis could represent a number of digits in a second operand of the problems addressed by the student.

In one embodiment, the data represented by the third axis is selectable. The data represented by the third axis is preferably selected from the group of data including the number of problems attempted, a number of correct responses, a number of incorrect responses, an average time required for each correct answer, and an average time for each incorrect answer. In one embodiment, the statistics displayed in the 3-dimensional graph are selectable according to mathematical operators employed in the problems. Preferably, the statistics relating problems employing different mathematical operators are displayed in different colors.

In still another embodiment of the present disclosure, a method of tracking a student's progress in developing math or other educational skills is provided. The method includes the steps of generating and sequentially displaying a number of problems to be solved by the student, receiving the student's answers to the problems, maintaining a database which records each problem presented to the student and every response received from the student to each problem presented, and displaying statistics regarding the student's performance in at least one of a number of selectable formats.

In one embodiment, the problems being generated and displayed are presented in a game-like format where the student is awarded points for providing correct answers to the problems. In addition, the next problem in a sequence of problems is not displayed until the correct answer has been received for the immediately preceding problem. An advantage of the present invention is that the next problem to be displayed can be harder or easier than the last problem depending on how the student has been performing up to that point.

In another embodiment, the selectable formats for displaying the statistics include at least one of a number of formats, such as a graphical format, an alpha-numeric text format, and a tabular format. Further, the displayed statistics can include, for example, any combination of a number of problems attempted by the student, a number of digits in a first operand of the problems attempted by the student, a number of digits in a second operand of the problems attempted by the student, the mathematical operator employed in each problem, the number of incorrect answers to each problem received from the student, the number of correct responses received from the student, the amount of time required for the student to answer each problem, and the average time to answer each problem.

In addition, the selectable formats for displaying performance may include a 3-dimensional graph. In an embodiment, the 3-dimensional graph includes a first axis and a second axis which relate to the complexity of the problems addressed by the student, and a third axis which relates to the student's performance on said problems. In one embodiment, the first axis represents the number of digits in the first operand of the problems addressed by the student, and the second axis represents the number of digits in the second operand of the problems addressed by the student. Preferably, the data represented by said third axis is selectable. For example, the data represented by the third axis may selectable from a group of data including the number of problems attempted, the number of correct student responses, the number of incorrect student responses, the average time for each correct answer, and the average time for each incorrect answer. By employing the present disclosure, the statistics displayed in the 3-dimensional graph are selectable according to mathematical operators, or problems having different mathematical operators may be displayed together using different colors.

In yet another embodiment of the present disclosure, a method of tracking a group of students' progress in developing math or other skills is provided. The method includes the steps of generating and sequentially displaying a number of problems to be solved by each of the students, receiving each of the students' answers to the problems, and maintaining a database which records each problem presented to each of the students and every response received from each of the students to each problem presented. Subsequently, statistics are displayed according to the method, where the statistics reflect the group of students' performance. The statistics are displayed in at least one of a number of selectable formats.

Details of embodiments of the present disclosure are described herein, and additional features and advantages of the present disclosure will be apparent from the following Detailed Description and the Figures.

### BRIEF DESCRIPTION OF THE FIGURES

FIG. 1 is a diagram illustrating an example screen for logging a student into a problem session.

FIG. 2 is a diagram illustrating an example screen for selecting parameters for a problem session.

FIGS. 3-10 are diagrams illustrating an example screen for displaying problems during a problem session.

FIG. 11 is a flow chart illustrating an example of a method for improving a student's math skills and tracking a student's performance.

FIGS. 12-20 are diagrams illustrating an example of performance statistics reflective of a student's overall progress record.

FIGS. 21-23 are flow charts illustrating an example of a method for analyzing student responses to control the level of difficulty of problems being presented.

FIGS. 24-27 are diagrams illustrating examples of different levels of difficulties of different types of problems to be presented to a student.

FIGS. 28-29 are diagrams illustrating examples of the regrouping process.

FIG. 30 is an example of a flow chart illustration for a method of controlling the level of difficulty of problems being presented.

### DETAILED DESCRIPTION

The present disclosure relates to a method and apparatus for improving a student's performance in math or other educational skills. The present disclosure improves a student's math skills by enabling the student to work at their own pace and by encouraging the student to continually aim for the correct answer. Accordingly, the present disclosed system is capable of changing the level of difficulty of the problems presented to the student as the student progresses in order to allow the students to learn at their own pace. In addition, it also enables one such as a teacher or parent to supervise, monitor and track the student's progress by compiling an ongoing record of the student's progress and performance statistics related to the student's progress. The student's progress record therefore may to be viewed and sorted by a number of statistical categories. Furthermore, the statistical record of the student's progress and performance can be utilized to control the level of difficulty of problems being presented to the student.

In one embodiment, a number of problems are generated and displayed, during a problem session, in a game-like format. In this embodiment, the student is awarded points for providing correct answers to the problems. Even though a game-like format is used in this embodiment, it should be appreciated that any suitable format can be used for presenting problems during a problem session.

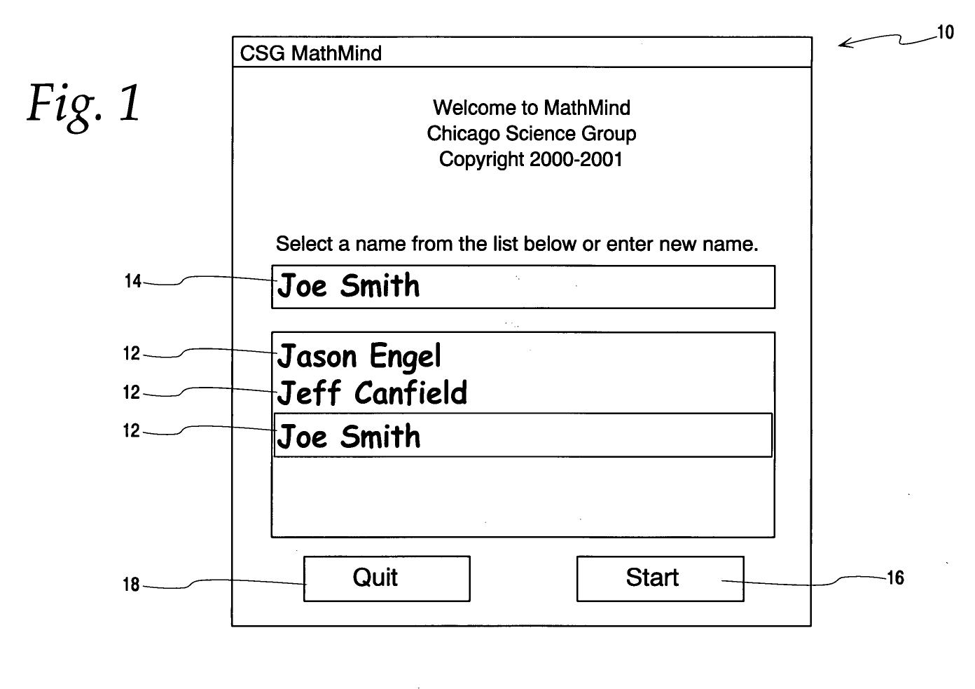

FIG. 1 shows a logon screen 10 for logging a student into a problem session. The student either selects their name from the listed names 12 or types their name in the selection space 14. If the student types their name in the selection space 14, then their name will be added to the listed names 12 the next time the student logs into a problem session. Here, the student has selected one of the listed names 12 as indicated by the highlighted name “Joe Smith,” thereby causing the name to be also be listed in the selection space 14. Once the student has selected or entered their name, they are ready to log into the problem session by pressing the start button 16. Alternatively, the student may quit without logging in by pressing the quit button 18. Once the student presses the start button 16, the problem session begins.

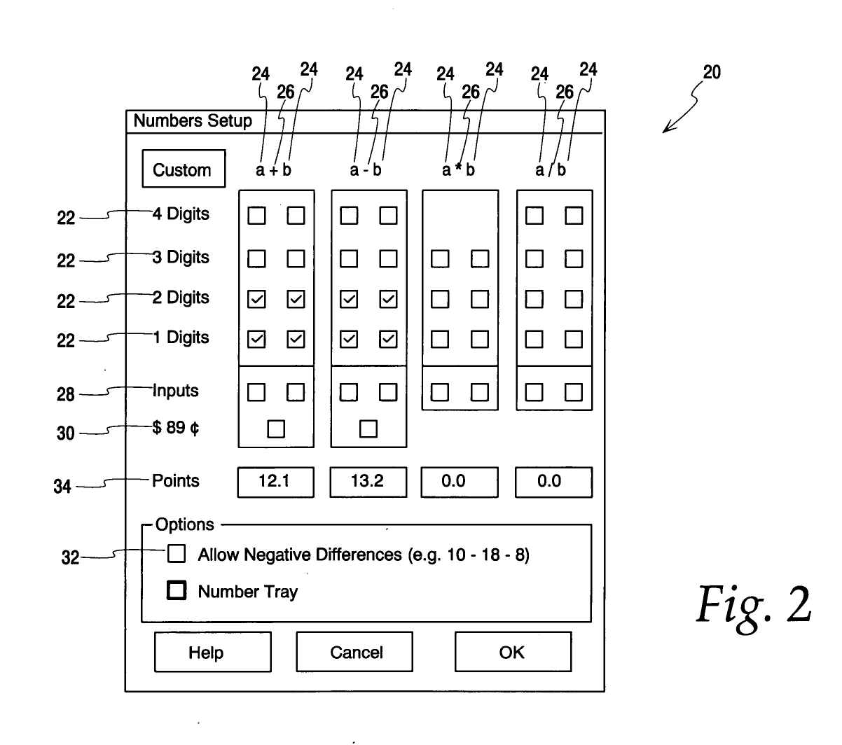

The problems displayed during the problem session may be customized. FIG. 2 shows a setup screen 20 for selecting or customizing parameters to be used for math problems to be displayed during a problem session. Although the examples described herein relate to problem sessions involving math problems, it should be appreciated that the invention can be practiced using any type of educational criteria and problems. Here, the number of digits 22 for each operand 24 of the problems displayed during the problem session may be customized. In addition, by selecting the number of digits 22 for each operand 24, the mathematical operators 26 to be employed with each of the operands 24 of the displayed problems may also be selected.

If desired, each of the operands 24 of the displayed problems can be customized to employ negative inputs 28. As an alternative to using standard numbers, the setup screen 20 enables the displayed problems to be customized to employ currency indicators 30. However, it should be realized that in the present example, the setup screen 20 currency indicators 30 are available for the mathematical operators 26 of addition and subtraction. The setup screen 20 also includes a negative differences option 32 that allows the use of negative differences for the answer to the displayed problems. In an alternate embodiment, the system automatically customizes the problems being displayed as described above based upon the student's responses and statistics related to the student's responses. Furthermore, the use of negative inputs and negative differences for answers can be utilized to provide for distinctions in levels of difficulties of problems presented to students.

As will be discussed below, the problem session awards points to the student for each correct answer. In one embodiment, the points awarded vary based on the level of difficulty selected for the problem session. Accordingly, the setup screen 20 displays the point base 34 for the number of digits 22, operands 24, and mathematical operators 26 selected. It should be appreciated that as the level of difficulty increases, the point base 34 preferably increases. For instance, increasing the number of digits 22 from “2 digits” to “3 digits” causes the point base 34 to increase. Thus, an increased level of difficulty generally results in an increased number of points awarded. In this manner, the student is encouraged to increase the difficulty level as their proficiency improves in order to receive the increased points awarded for more difficult problems. Alternatively, the level of difficulty is automatically changed based upon the student's performance in order to challenge the student and keep the student entertained without discouraging the student from learning.

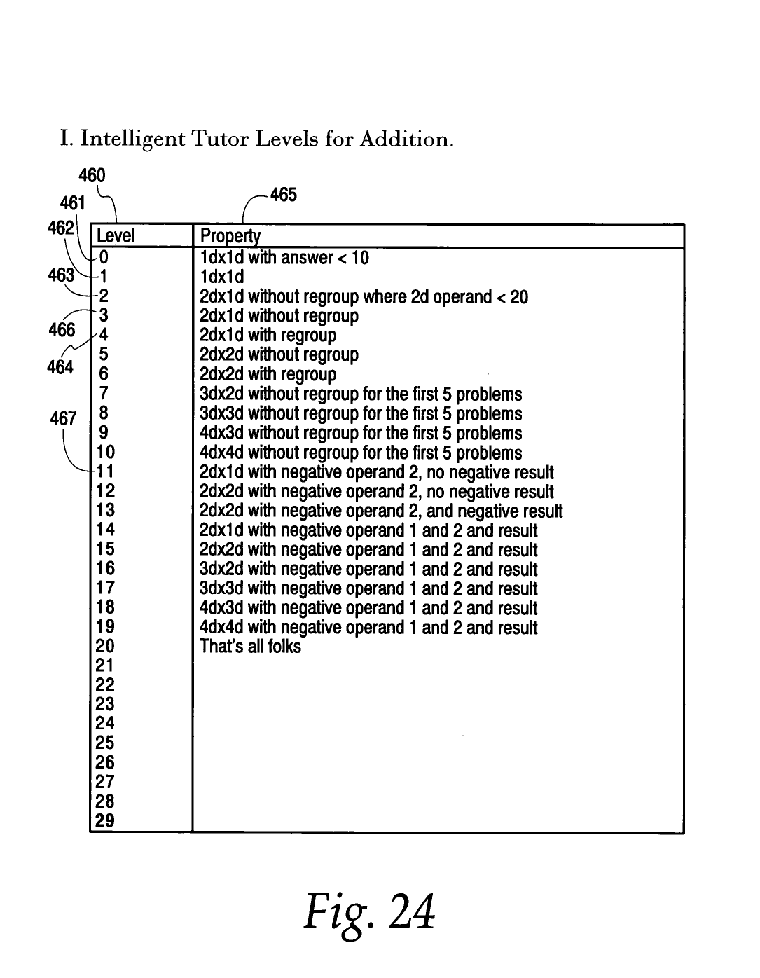

In an embodiment, the answer to the displayed problem can be limited. For instance, the answer could be required to be less than or equal to an integer N. Thus, each answer to the displayed problem would be less that or equal to N, where N is an integer. In an embodiment, N is a whole positive number. It should be appreciated that limiting the answer in this fashion allows for the customization of the level of difficulty of the displayed problems. For example, FIG. 24 shows that for the first level of difficulty 462, the answer to problems displayed must be less than the number 10. Further examples of distinctions between the levels of difficulties will be explained herein.

In the above-described embodiment, the customization parameters are directed towards the level of difficulty of the problems displayed during the problem session. However, it should be appreciated that any suitable parameters may be customized during the problem session. For example, the format in which the equations or problems are displayed on the screen may be customized. In one embodiment, the problems are displayed in a vertical format. Alternatively, the problems may be displayed in a horizontal format. It should also be appreciated that the parameters that influence the level of difficulty of the problems displayed can be automatically changed during a problem session in order to allow a student to learn at their own pace.

In addition, the algebraic format of the equations or problems can be customized. In one embodiment, the solution to the displayed problem is the only unknown value, that is, the student correctly answers the displayed problem by supplying the correct solution. Alternatively or in combination with solution to the displayed problem, the unknown value could include the mathematical operator and either of the operands. Therefore, the student might be required to supply the mathematical operator or the missing operand from the displayed problem in order to correctly answer the displayed problem.

Once the problem session parameters have been customized as desired, the problem session begins. These parameters can be established at the start of a problem session or can be preset. It should be appreciated however that the problem session parameters do not have to be customized each time a problem session begins. Accordingly, in an embodiment, default problem session parameters are used to begin a problem session. In another embodiment, the session parameters from the student's previous session may be used as the default parameters. FIGS. 24-27 illustrate examples of default levels of difficulties that can be used to control the types of math problems being presented to students. FIGS. 24-27 will be further explained herein.

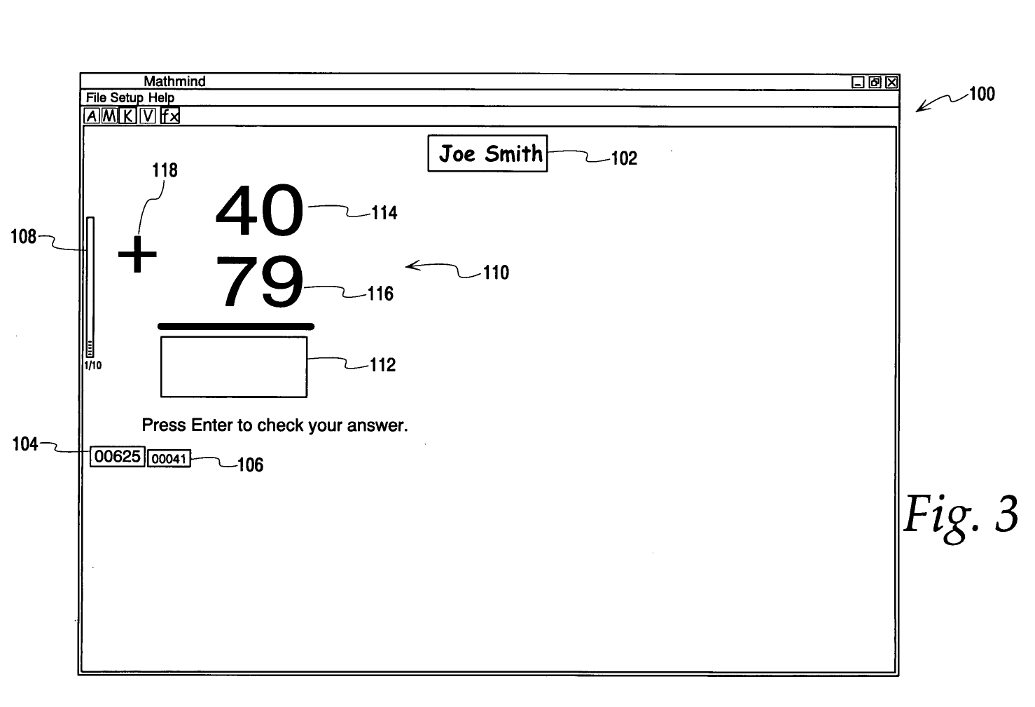

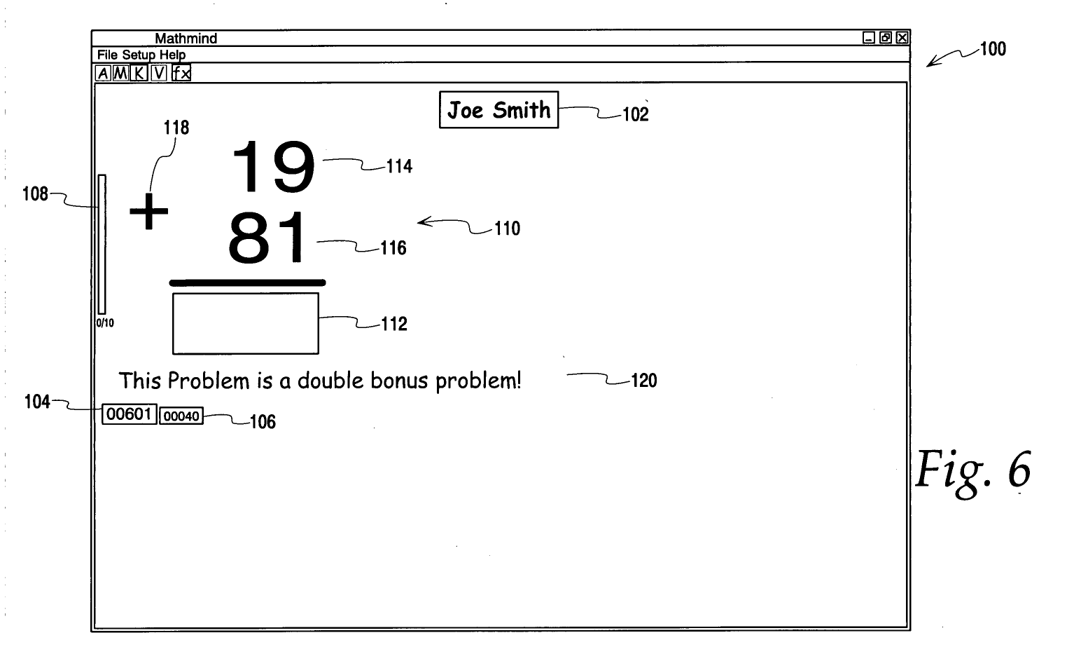

FIGS. 3-10 are diagrams illustrating a problem screen 100 for displaying problems during a problem session. The problem screen 100 in FIGS. 3-5 illustrates a first displayed problem. The problem screen 100 in FIGS. 6-10 illustrate a second displayed problem. The problem as displayed in FIGS. 3-10 collectively illustrate various portions of a problem session according to one embodiment of the disclosed system.

Referring now to FIG. 3, the student's name 102 is displayed in the center of the problem screen 100, thereby indicating that a problem session has been initiated for the named student 102 and that the results of the problem session will be stored as part of the named student's overall progress record and performance statistics. The student's overall point total 104 and overall number of correct answers 106 are also displayed in the problem screen 100.

In addition, progress meter 108 indicates how many questions the student has answered correctly for this problem session. The progress meter 108 indicates that the student has already correctly answered one out of ten questions. In one embodiment, the progress meter 108 resets to zero after the student correctly answers ten questions. Alternatively, the progress meter 108 may be reset after any suitable number of questions have been correctly answered. It should also be appreciated that the progress meter 108 could be used to indicate the end of a problem session. Therefore, the progress meter 108 could be used to show that the problem session ends when the student has correctly answered, for example, ten problems.

The problems 110 displayed in FIGS. 3-5 includes a first operand 114, a second operand 116, an operator 118 and a solution window 112. The first operand 114 is the number forty, the second operand 118 is the number 79 and the operator 118 is the + symbol for addition. Thus, the student must correctly answer the problem 40+79=? and enter the correct answer in the solution window 112.

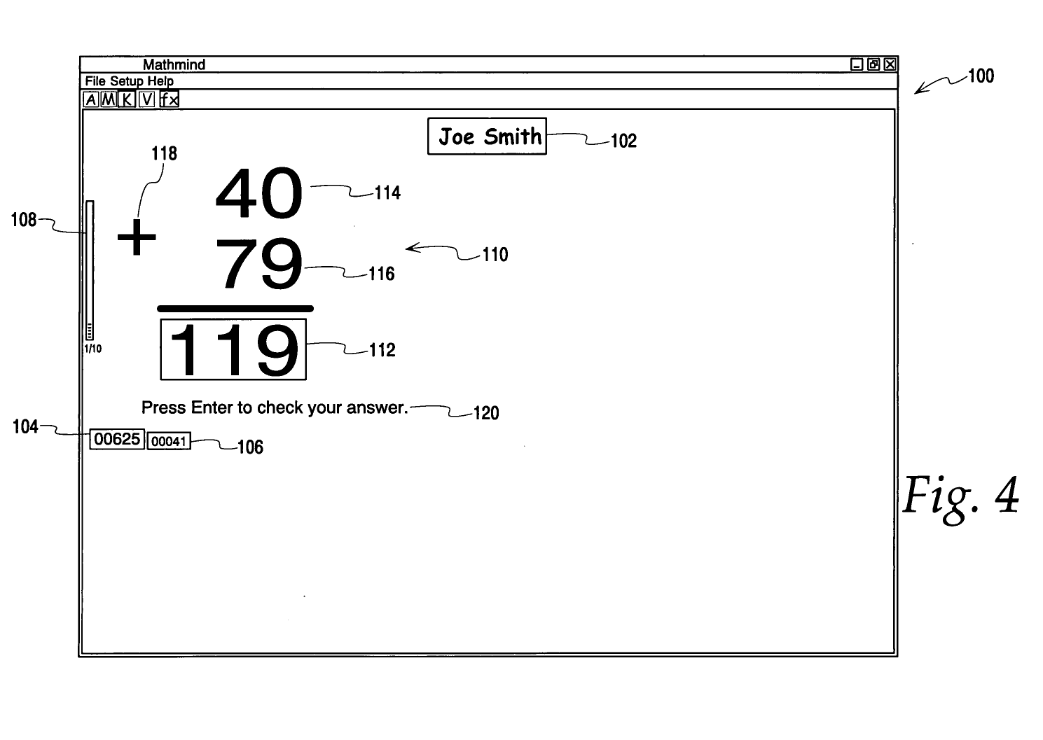

Referring now to FIG. 4, the student has performed the calculation indicated by the displayed problem and has entered an answer in the solution window 112. In this case, the student has entered the number “119” into the solution window 112. As indicated by answer prompt 120, the student must press the enter button (not shown) on the keyboard to check the answer. In this embodiment, the student presses the enter button to check the answer, but it should be appreciated that any suitable button on the keyboard could be used to check the student's answer. Alternatively, the student could be required to press or click a button (not shown) on the problem screen 100 in order to check the answer.

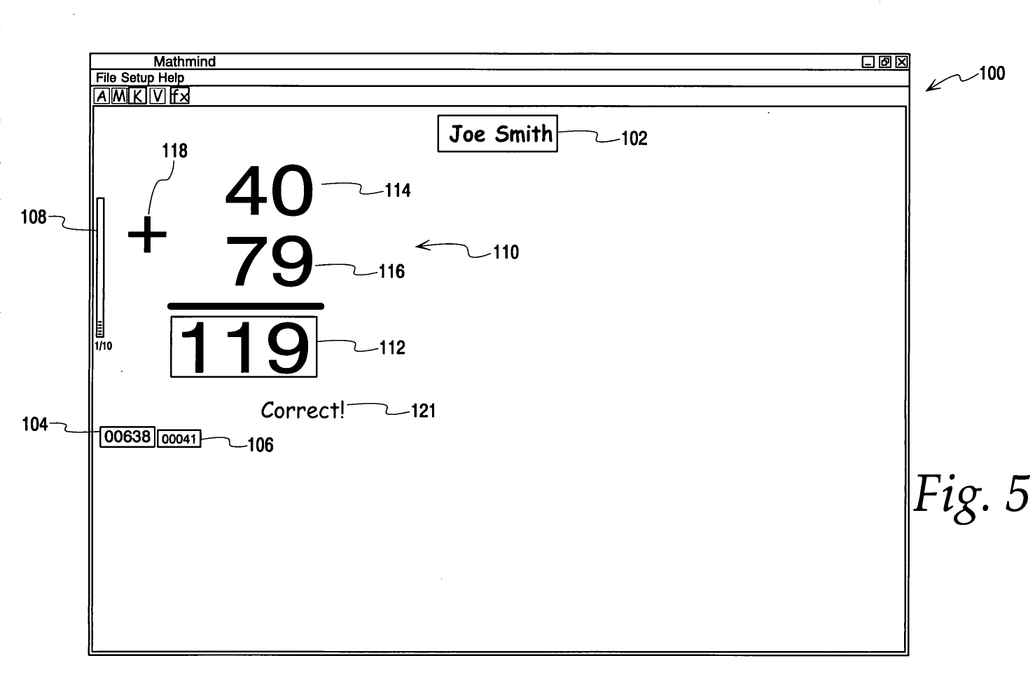

In FIG. 5 the student has answered the problem and pressed the enter button to check the answer. The answer supplied by the student, “119”, is correct as indicated by answer prompt 121. In addition, the student's overall point total 104 has been updated from “625” to “638” to reflect the points awarded (i.e., thirteen points) to the student for correctly answering the displayed problem 110. After awarding the points for the correct answer, the problem session automatically advances to the next displayed problem and the problem session continues in this fashion.

The problem screen 100 shown in FIGS. 6-10 shows a previous problem 110 from the same problem session.

In this problem the first operand 114 is the number nineteen, the second operand 116 is the number eighty-one, and the operator 118 is again the addition symbol “+”. Thus, to correctly solve this problem the student must enter the correct value for the problem 19+81+? in the solution window 112. The main difference between the problem displayed in FIGS. 6-10 and that displayed in FIGS. 3-5 (other than the different operands) is that the problem in FIGS. 6-10 has been designated as a “double bonus problem”, as indicated in the answer prompt 120.

Once the student correctly answers the displayed problem 110, points will be awarded to the student, as described above. However, since the displayed problem 110 is a double bonus problem, the points awarded to the student will be doubled. In one embodiment, double bonus problems occur randomly. Alternatively, double point bonuses are awarded for problems with a predetermined level of difficulty.

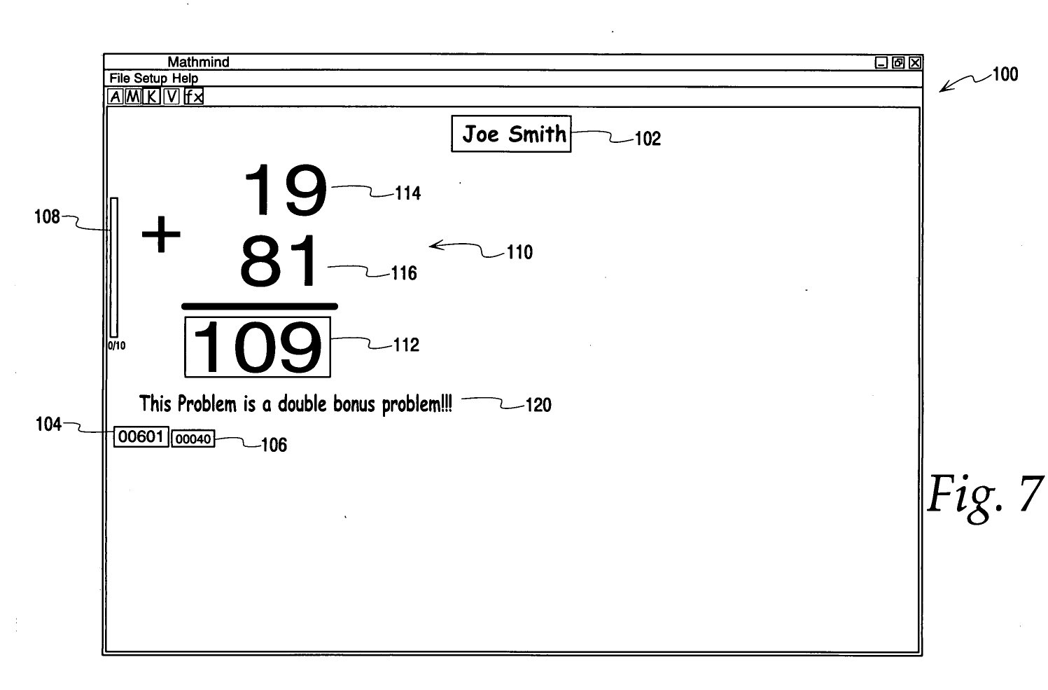

Referring now to FIG. 7, the student has performed the calculation indicated by the displayed problem 110 (i.e., 19+81=?) and has entered an answer in the solution window 112. The answer entered by the student is the number “109.” As described above, the student must press the enter button on the keyboard to check the answer.

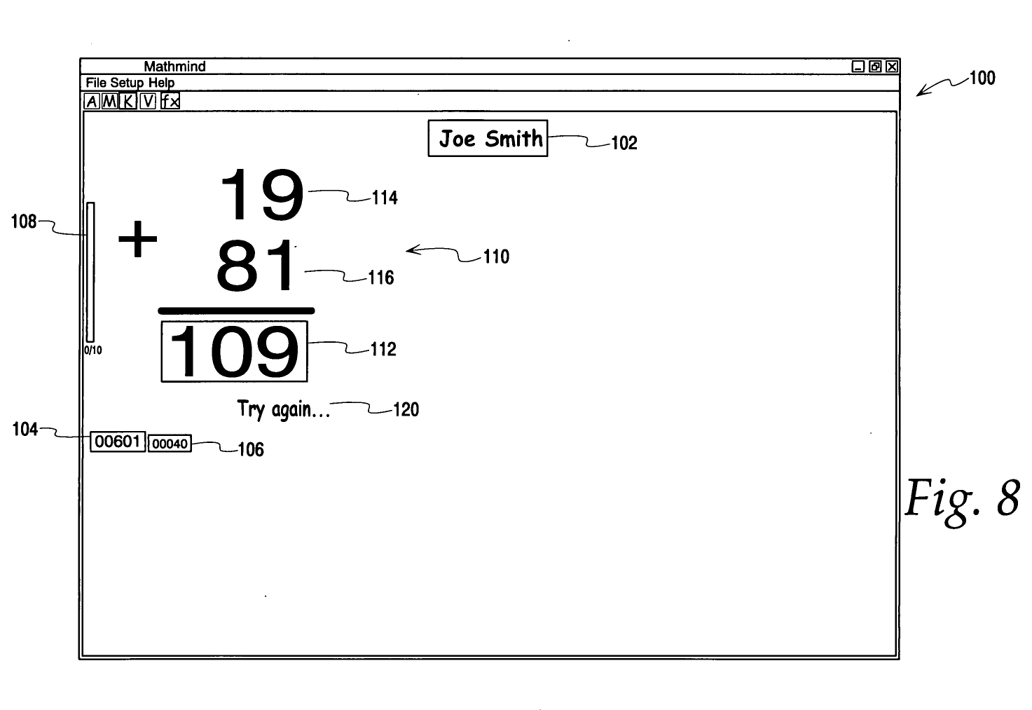

After pressing the enter button, the answer prompt 120 indicates whether the answer or response provided is correct or incorrect. As shown in FIG. 8, the attempt or response of “109” is incorrect and the answer prompt 120 encourages the student to try again. Thus, the student may again attempt to provide the correct answer. In this manner, the problem session encourages the student to keep trying until they provide the correct answer. Accordingly, the student is able to work at their own pace. In addition, performance statistics relating to the number of attempts entered by the student working on each problem until they get it right are stored so that the data can be used to identify areas where improvement may be needed. In addition, the performance statistics can be used to change the level of difficulty of the problems in order to allow the students to work at their own pace. For example, if the student is unable to answer the problem correctly after a number of attempts, or after a certain time period, the level of difficulty of the next problem can be reduced to a level where the student can improve on the skills necessary to correctly answer problems at the more advanced levels.

As such, the statistics which are recorded for each problem can be analyzed to determine whether subsequent problems should be more difficult or easier based on the student's performance. A decision to make future problems easier, maintain the same level of difficulty or increase the level of difficulty may be made based on historical performance. When such an analysis indicates that the student is making fewer mistakes and responding faster, harder problems may be generated to keep pace with the student's progress.

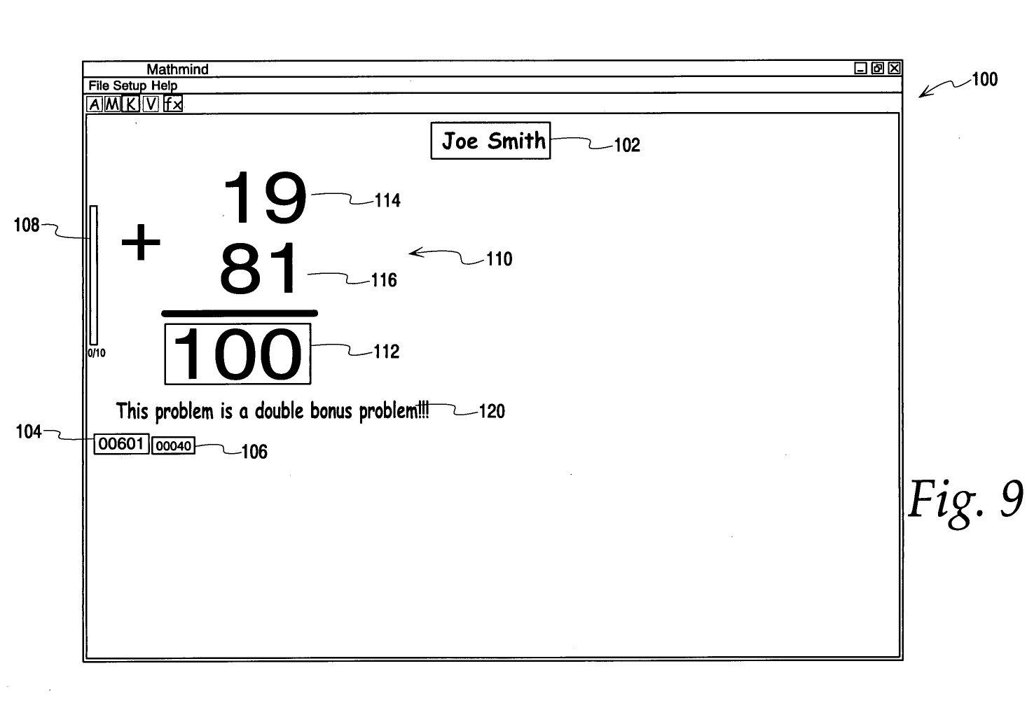

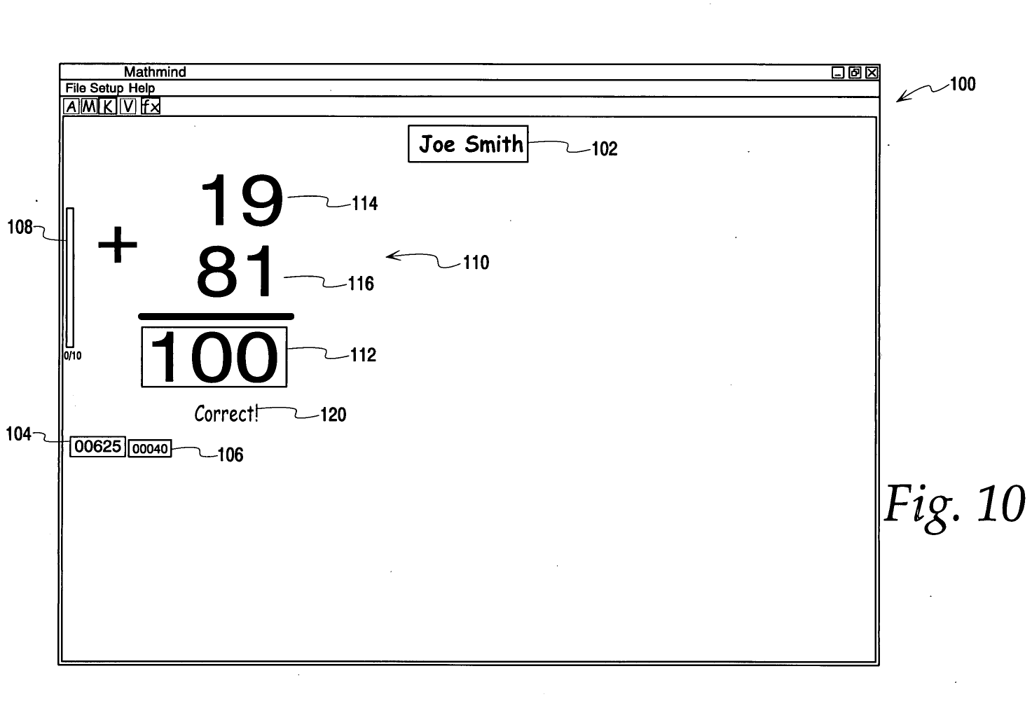

In FIG. 9, the student has again entered an answer in the solution window 112. The answer entered by the student in this second attempt is the number “100.” Again, the student must press the enter button on the keyboard to check the answer. This time the answer is correct, as indicated in FIG. 10. The student has pressed the enter button to check their answer. The answer “100” entered in the solution window 112 on the student's second attempt is correct as indicated by answer prompt 120. In addition, the student's overall point total 104 has been updated from “601” to “625” to reflect the double points awarded (i.e., twenty-four points) to the student for correctly answering the displayed problem 110. As described above, after awarding the points for the correct answer, the problem session automatically advances to the next displayed problem and the problem session continues in the same manner.

In an embodiment, the student can press a reveal button (not shown) such as the space bar when they do not know or are having trouble calculating a correct response to a displayed problem, thereby skipping the problem. Pressing the reveal button allows the student to reveal the answer to the displayed problem and causes the problem session to automatically advance to the next problem. In an embodiment, the number of times the student presses the reveal button and the problem associated with pressing the reveal button will be recorded in the student's progress record, thereby offering further insight into a student's progress. In an embodiment, skipped problems are included in the total number of attempts by the student.

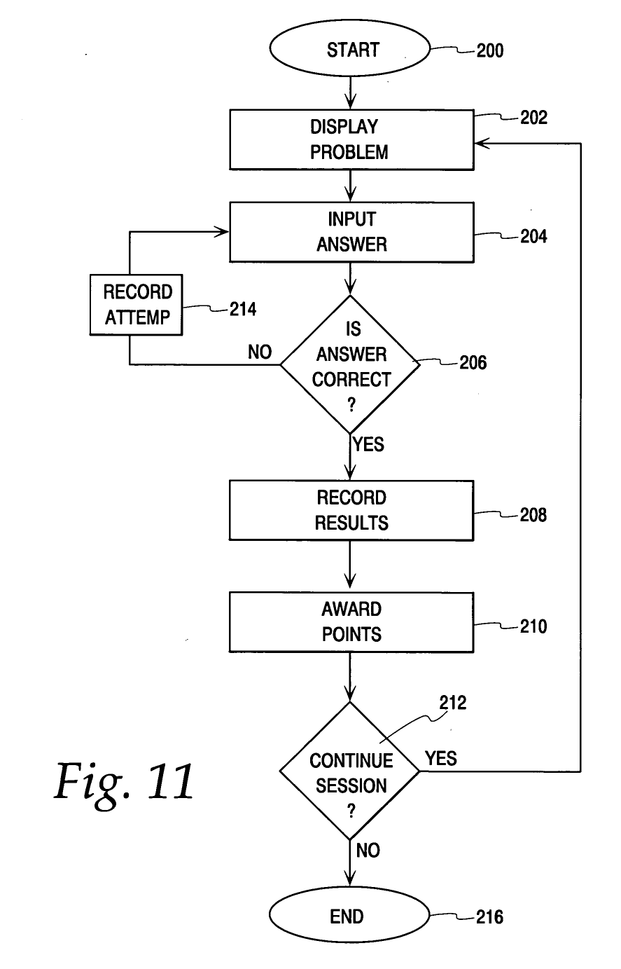

FIG. 11 is a flow chart illustrating an example method for improving a student's math skills and tracking a student's performance. The method starts by initiating a problem session at step 200. At step 202, a problem is displayed to the student, and at step 204, the student enters an answer to the displayed problem. Once the student has entered a response a determination is made at step 206 whether or not the supplied answer is correct.

If the supplied answer is not correct, then the attempt is recorded at step 214, that is, the information concerning the attempt including the incorrect answer that was entered is recorded. The problem session then returns to step 204 where the student is allowed to re-enter an answer to the displayed problem. The problem session proceeds in this fashion until the student enters the correct answer. Once the student supplies the correct answer to the problem, the problem session proceeds to step 208 where the results are recorded. The results recorded at step 208 include the answer to the problem, the type of problem answered and the time taken to answer the problem.

At step 210, points are awarded to the student for correctly answering the problem. Once processing for a given problem is complete, a check is made at step 212 to see whether the problem session is to continue. In one embodiment, the problem session ends only when the student affirmatively ends the problem session. In an alternative embodiment, the problem session automatically ends after a predetermined number of problems have been answered correctly. If the problem session is to continue, then the problem session proceeds to step 202 where a different problem is displayed and the process repeats in the manner described above. If the problem session is to end, then the problem session ends at step 216.

As described above, an overall progress record is preferably maintained for each student. The progress record includes data relating to the student's performance in problem sessions. The progress record, including performance statistics derived from the student's performance, may be sorted and viewed in multiple selectable formats. The performance statistics can also be utilized to determine whether or not to change the level of difficulty of problems being presented to the student. Performance statistics reflecting the student's recorded progress record may be selectively parsed and compiled, and then displayed in a graphical manner.

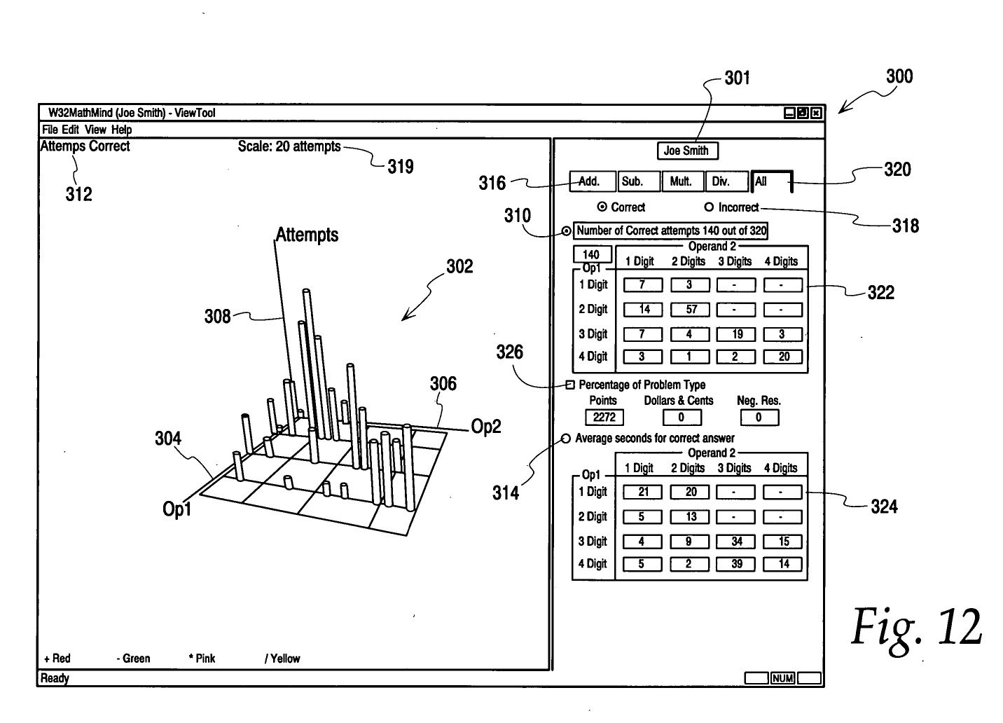

FIGS. 12-20 are example diagrams illustrating performance statistics reflective of a student's overall progress record, and the various ways in which they may be presented. A performance screen 300 is shown in FIG. 12. The performance screen 300 illustrates performance statistics for the named in the student I.D. field 301. The performance screen 300 includes a 3-dimensional graph 302 having a first axis 304, a second axis 306 and a third axis 308. In the embodiment shown, the first axis 304 represents the number of digits in the first operand of the problems answered by the student and the second axis 306 represents the number of digits in the second operand. The third axis 308 represents selectable data, including for example, the number of problems attempted by the student, the number of correct attempts or responses, the number of incorrect attempts or responses, the average time required to enter each correct answer and an average time required for each incorrect answer. It should be appreciated that additional data can be stored and selected, as will be further described herein.

The third axis 308 in the embodiment shown in FIG. 12 corresponds to the number of correct attempts as indicated by attempts selector 310 and graph title 312. The attempts selector 310 as well as seconds selector 314 are selectable options that allow the user to choose between displaying the number attempts or third axis 308. In addition, the user may select between correct and incorrect attempts and between average seconds for correct answers and average time for incorrect answers by selecting the correct selector 316 or the incorrect selector 318. In the displaying window shown in FIG. 12, since both the correct selector 316 and the attempts selector 310 are selected, the third axis 308, represents the number of correct attempts. Further, it should be appreciated that the data presented in the 3-dimensional graph 302 is scaled as indicated by scale legend 319.

The 3-dimensional graph 302 may be employed to display data for each of the selected mathematical operators (i.e., addition, subtraction, multiplication and division) either individually or collectively. In FIG. 12, the data are collectively displayed because operator selector 320 “All” has been selected, thereby indicating that data for all of the mathematical operators are to be displayed on the 3-dimensional graph 302. It should be appreciated that the data for the mathematical operators displayed on the 3-dimensional graph 302 can be distinguished by using different colors or shading for each unique operator.

Performance screen 300 also includes an attempts table 322 and a seconds table 324 which displays the performance data in a tabular format rather than a graphical format. The data displayed by the attempts table 322 and the seconds table 324, like the data displayed by the 3-dimensional graph 302, also may be selectively displayed in a manner similar to that described above. Performance screen 300 further includes a percentage selector 326 which enables the user to selectively view the attempts table 322 as the percentage of correct or incorrect attempts rather than the raw number of correct or incorrect attempts.

It should be appreciated that the data selectively presented by 3-dimensional graph 302, attempts table 322 and seconds table 324 provides an extensive and adaptive way for a user to view a student's progress record and present performance statistics. In addition, it will be evident from the following figures that the data can be selectively presented in a way that isolates problem areas or areas that may need improvement as well as areas in which a student excels.

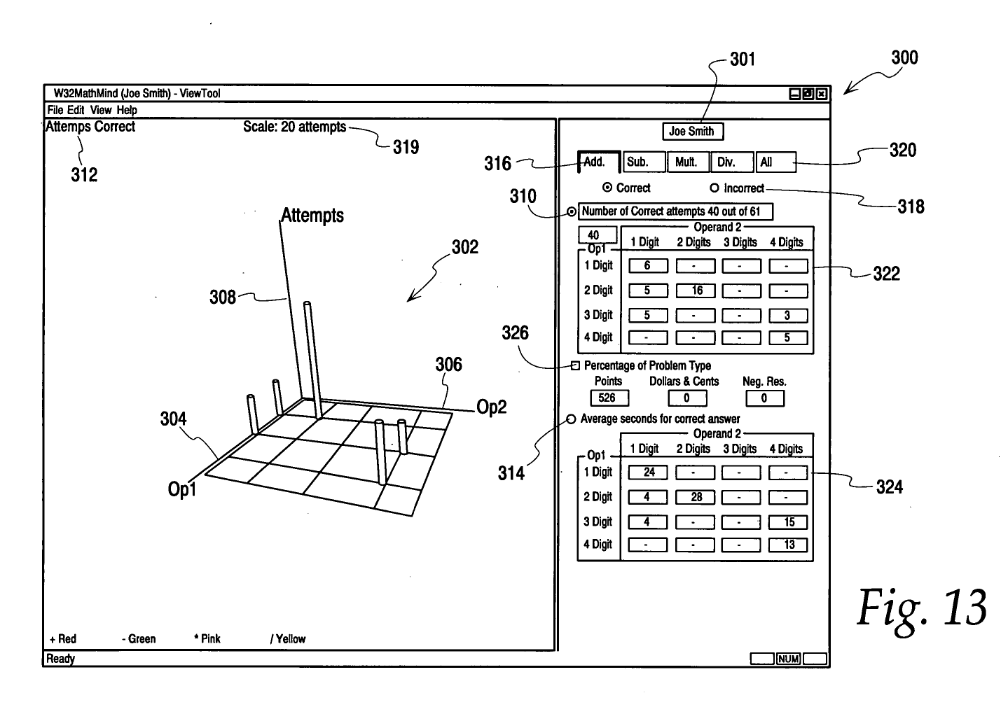

The problem screen 300 in FIG. 13 includes the 3-dimensional graph 302 which displays the number of correct attempts for addition problems only. This display mode is accessed by selecting operator selector “Add.” 320 Likewise, the attempts table 322 and the elapsed time table 324 display only performance data relating to currently answered addition problems. When the performance statistics are limited to a single area in this manner, the graph is easier to read and it is easier to identify the student's problem areas as well as determining their strengths.

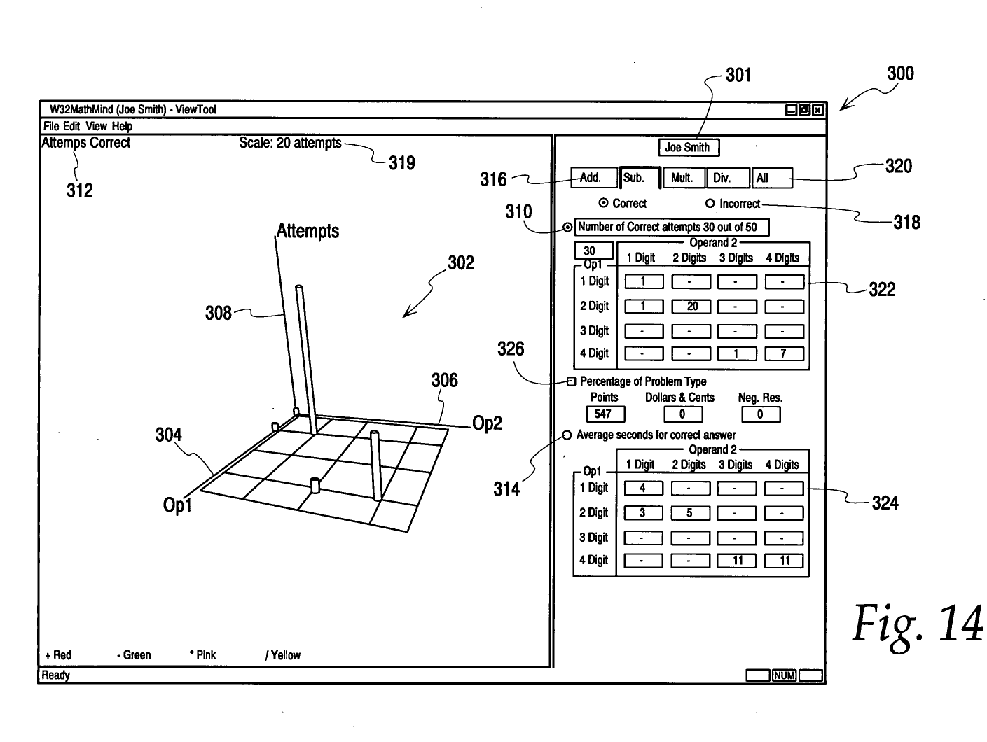

The 3-dimensional graph 302 displayed on the performance screen 300 shown in FIG. 14 displays only the number of correct attempts for subtraction problems. This display mode is accessed by selecting the operator selector “Sub.” 320. Similarly, the attempts table 322 and the elapsed time table 324 display only performance data relating to correctly answered subtraction problems. Again, viewing performance information that has been limited to a single mathematical operator allows the user to more easily identify the student's strengths and weaknesses. For example, it is easy to see from the graph 302 and the attempts table 322 that a majority of the problems that the student answered correctly were subtraction problems having “2 digits” in each operand.

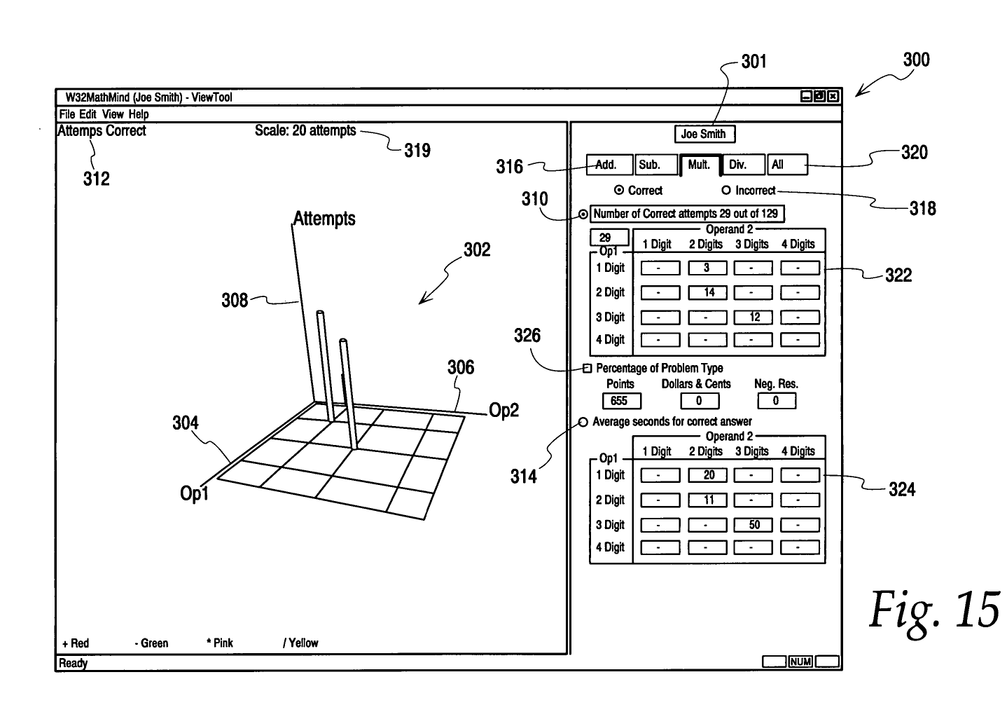

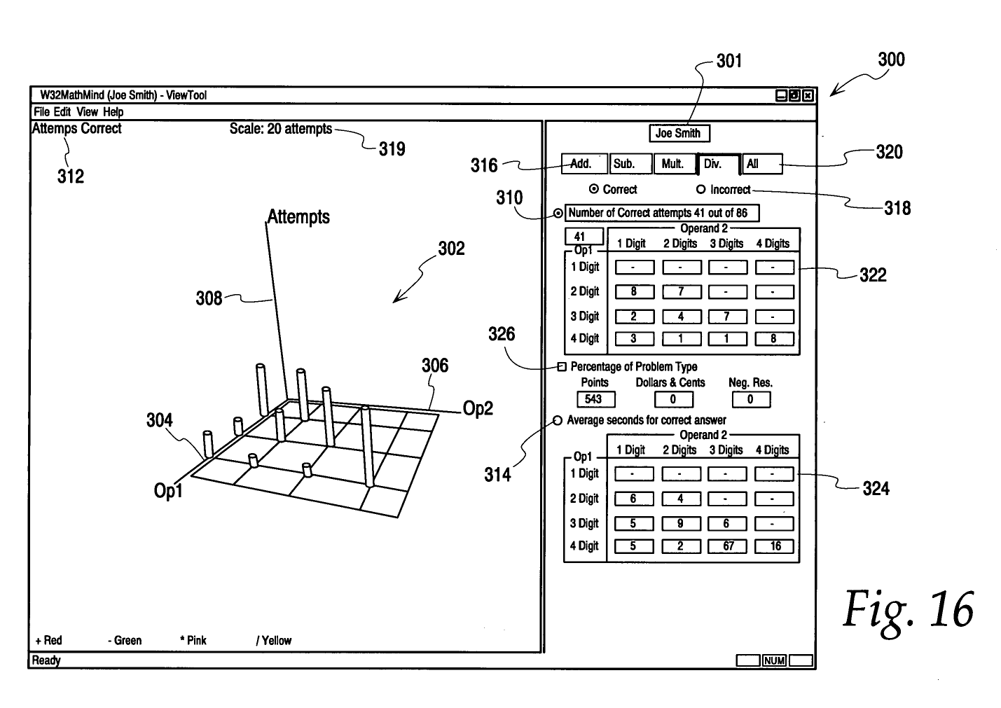

The problem screen 300 in FIG. 15 includes the 3-dimensional graph 302 which displays the number of correct attempts for multiplication problems only. This display mode is accessed by selecting the indicated operator selector “Mult.” 320. Again, the attempts table 322 and the elapsed time table 324 display only performance data relating to correctly answered multiplication problems. Similarly, the 3-dimensional graph 302, the attempts table 322 and the elapsed time table 324 of FIG. 16 all display performance data for division problems only as indicated by the selection of operator selector 320 “Div.”

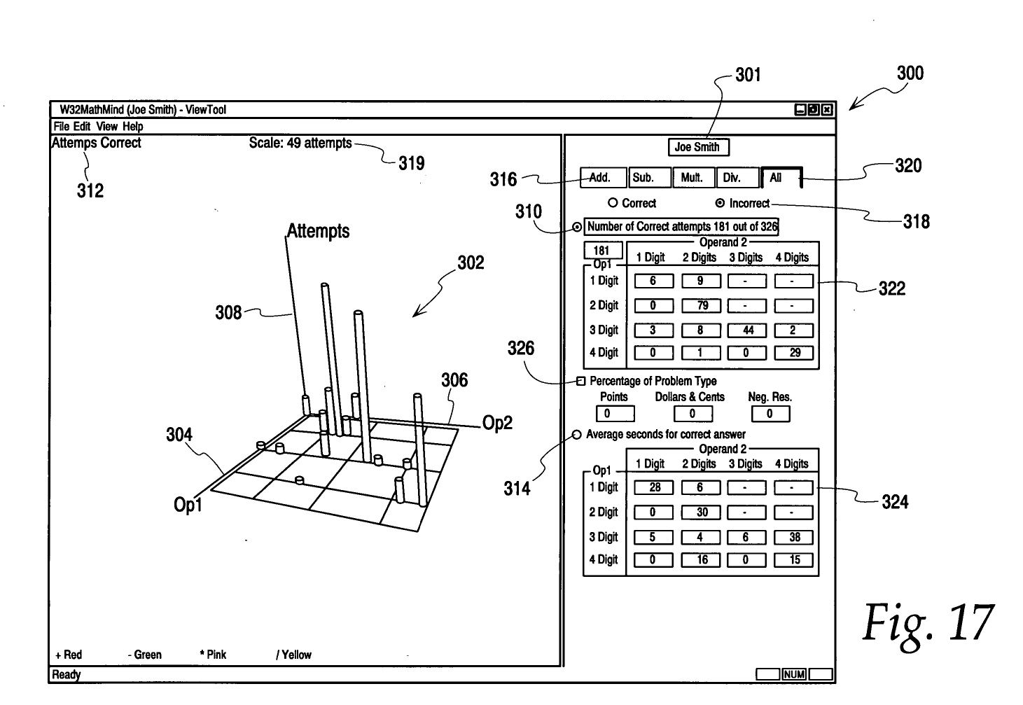

The problem screen 300 in FIG. 17 includes the 3-dimensional graph 302 which displays the number of incorrect attempts for all problems as indicated by the selection of operator selector 320 “All” and selection of the incorrect selector 318. Similarly, the attempts table 322 and the elapsed time table 324 also display performance data relating to all incorrect answers and attempts. It should be appreciated that the displayed data and the selectable options make it much easier to identify a student's potential strengths and weaknesses. For example, the student named in the student I.D. field 301 did not incorrectly answer any problems where the first operand included “2 digits” and the second operand included “1 digit”, indicating a possible strength. Conversely, the student incorrectly answered a large number of problems where both operands included “2 digits”, indicating an area of weakness. It should be appreciated that evaluating the incorrect answers and attempts by viewing only selected mathematical operators could further isolate and identify the areas where a student may excel or may need improvement.

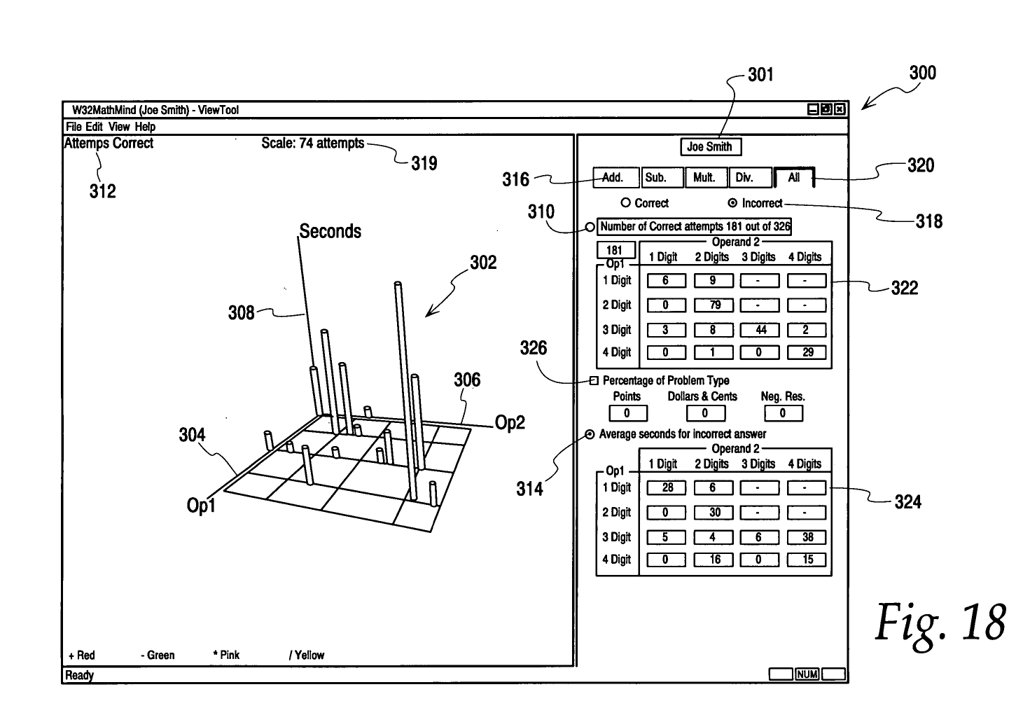

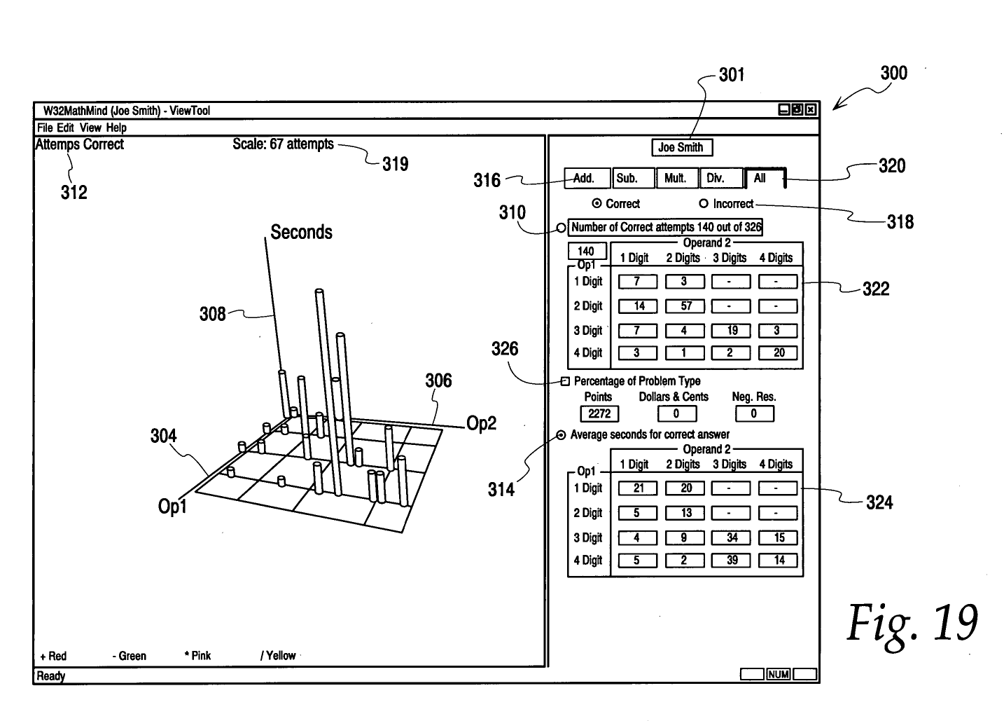

As shown in FIG. 18, the performance screen 300 includes the 3-dimensional graph 302 where the third axis 308 has been selected to represent the average number of seconds for each incorrect answer to be entered for problems involving all four operators. This display mode is accessed by selecting the incorrect selector 318, operator selector “All” 320 and seconds selector 314. Similarly, the third axis 308 in the 3-dimensional graph 302 in FIG. 19 shows the average number of seconds required for the student to enter the correct answers for all problems. As with the other display modes the user may further examine the data by viewing only problems involving a single mathematical operator. It should be appreciated that the ability to examine performance based on the number of attempts and the average amount of time for answers to be entered, both for correct and incorrect answers, offers the user flexibility in examining a students performance and additional insight into the student's progress. It should also be appreciated that the ability to examine performance based on the number of attempts and the average amount of time for answers to be entered, both for correct and incorrect answers, offers flexibility in controlling the level of difficulty of problems being presented to the student to help advance the student's progress.

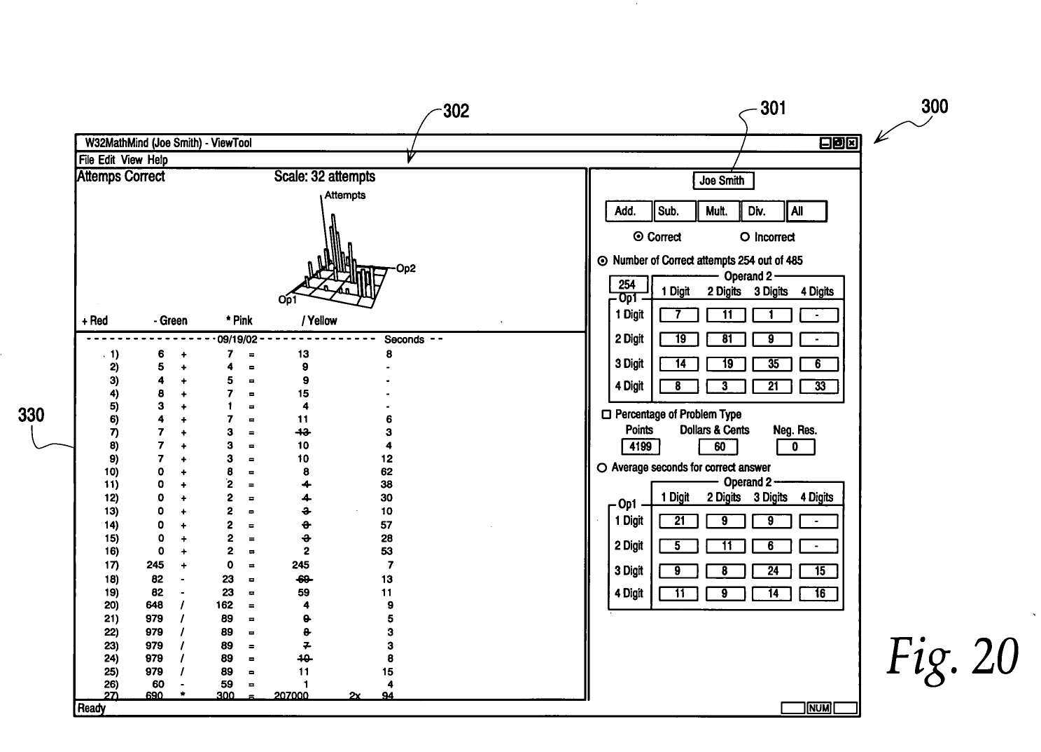

In an embodiment, the 3-dimensional graph 302 may be physically manipulated to assist the user in viewing the data contained in the graph 302. Accordingly, the user may physically rotate the graph 302 in 3-dimensions to better view and examine all of the performance statistics contained in the graph 302. As an illustration of this capability, the 3-dimensional graph 302 shown in FIG. 20 has been rotated from the position shown in FIGS. 12-19.

FIG. 20 shows an additional feature of the example performance screen 300. As shown in FIG. 20, the performance screen 300 may further include a text window 330. Text window 330 displays information for each of the problems attempted by the student. The information displayed in text window 330 may include the date each of the problems that were attempted (not shown), the sequential number of the problems attempted, as well as the problems themselves, and each response made by the student, whether correct or incorrect, and the number of seconds taken by the student for each attempt. In addition, the text window includes information indicating whether or not the displayed problem was a double bonus problem.

In one embodiment, the text window 330 includes information relating the student's use of the reveal button, described above. For instance, problems 2) to 5) in text window do not have a number of seconds per attempt associated with them. Instead, there is a “-” (dash) associated with each of these problems under the seconds heading. The use of the “-” (dash) is one indicator that the student used the reveal button. In addition, colors can be used to further identify and distinguish the type of answer. For example, a correct answer could be shown in a first unique color, an incorrect answer could be shown in a second unique color and a revealed answer could be shown in a third unique color. Thus, the text window 330 further enhances the tracking and monitoring ability of the system.

The above-described problem session employing the problem screen 100 may be generated in one embodiment using computer software or the like. In an embodiment, the problem session runs on a personal computer and the students' overall progress records including performance statistics, are stored on a memory device within the personal computer. Similarly, the performance screen 300 for displaying the students' overall progress record and performance statistics can also be generated and displayed using computer software operating on a personal computer or the like. Thus, the students' progress record can be accessed and parsed and the performance statistics can be compiled using, for example, a computer having a processor, a display and an appropriate memory device.

In another alternative embodiment, the problem session is run from a centralized location such as a centralized computer or collection of computers (e.g., a server). Thus, the problem session is capable of being distributed to a number of students via a computer network, such as an internet or an intranet. In this fashion, each student is able to access the problem session using a client program (e.g., a web browser). Running the problem session from a centralized location enables each of the student's progress records to be recorded in a centralized location, thereby facilitating data compilation and analysis. Further, it enables a student to access the problem session from a remote location which can be beneficial if, for example, a student is out of town to attend a funeral or a student is forced to miss an extended period of time in school due to a medical condition.

In another alternative embodiment, the problem session runs on a handheld device or a handheld computing device. Suitable handheld computing devices include but are not limited to laptop or palmtop computers such as a personal digital assistants. Personal digital assistants are desirable in that they are generally programmable and can easily and inexpensively be configured to meet the needs of the present system. Additionally, most handheld computing devices include synchronization functions that allow data stored on a memory device within the handheld device to easily be transferred from the handheld device to another device such as a personal computer or a computer network.

Accordingly, a student may complete a number of problem sessions on a handheld computing device. The student's ongoing progress record can be temporarily stored on the handheld device and then transferred directly to a personal computer or a computer network via the handheld device's synchronization function. Once the student's data has been transferred to the personal computer, a teacher, parent, or other interested person may selectively view the student's progress record and performance statistics to monitor and track the student's mathematical performance. In addition, the teacher or parent could also merge the student's progress record with the student's preexisting progress record to maintain an ongoing overall progress record. The teacher or parent could also export a student's progress record in a readable format such as that shown in text window 330 of FIG. 20.

In a further alternative embodiment, the problem session runs on a video game console. Accordingly, it should be appreciated that the apparatus for running problem sessions according to the present system can be any suitable device having a processor, a display and an input device for receiving input from the student.

Further, it should be appreciated that a teacher could use the present system to monitor the progress of an entire class or group of students. In addition, the teacher could compile overall class or group statistics to assist, for example, in preparing for standardized or performance tests. Even further, the collated statistics gathered from a large body of student's can be used for assessment purposes for monitoring the effectiveness of teachers, schools and entire school districts. The statistics can also be used to compare school districts, and the like.

In an embodiment, data recorded according to the present system (e.g., progress records) can be used in place of year-end arithmetic achievement or performance tests. Using this data provides an overall record of a student's performance. The present system therefore compensates for a number of situations, such as absent students on test days or student's who may not perform optimally under exam conditions. It should be appreciated that unlimited analysis methods or procedures can be applied to the recorded data for performance measurement or enhancement purposes. It should also be further appreciated that the recorded data of the present system can be used to evaluate and determine when to change the level of difficulty of problems being presented to a student.

FIGS. 24-27 illustrate embodiments for different levels of difficulties of problems to be presented to students. The level of difficulty of problems presented to students can depend on a number of different properties. The level of difficulty can be increased or decreased depending on these properties in a multitude of variations. For example, one way to alter the level of difficulty is to present addition problems for a first level of difficulty, subtraction problems as a second level of difficulty, multiplication problems as a third level of difficulty and division problems as a fourth level of difficulty, or any combination thereof. Alternatively, the student may be presented problems at a first level of difficulty wherein the student is required to provide an answer to a displayed problem, and may then be presented problems at a second level of difficulty wherein two operands or numbers are displayed and the answer to the problem is displayed, but wherein the student is required to provide the operator needed to generate the answer being displayed.

Alternatively, a number of other properties can be used to alter the level of difficulty. For example, one such property can be presenting problems to a student that include a negative input or negative operand as part of the problem. Therefore, a student would be presented a first set of problems at a first level of difficulty where none of the operands include a negative input, and can then be presented problems at a second level of difficulty wherein one of the operands is a negative input. Additionally, the student could be presented problems at a third level of difficulty wherein both operands are negative input.

Another property that can be used to delineate between levels of difficulty is by providing operands with different maximum digit ranges associated with each level. For example, students presented problems at a first level would only be presented operands with a maximum digit range of 1. As such, using addition, for example, the first level would contain problems where neither operand could exceed the number 9. At a second level, a student could be presented problems where one of the operands has a maximum digit range of 2 and the other operand has a maximum digits range of 1. As such, students being presented problems at this level of difficulty would encounter problems wherein one of the operands could not be greater than the number 9 and wherein the other operand could range from 0 to 99.

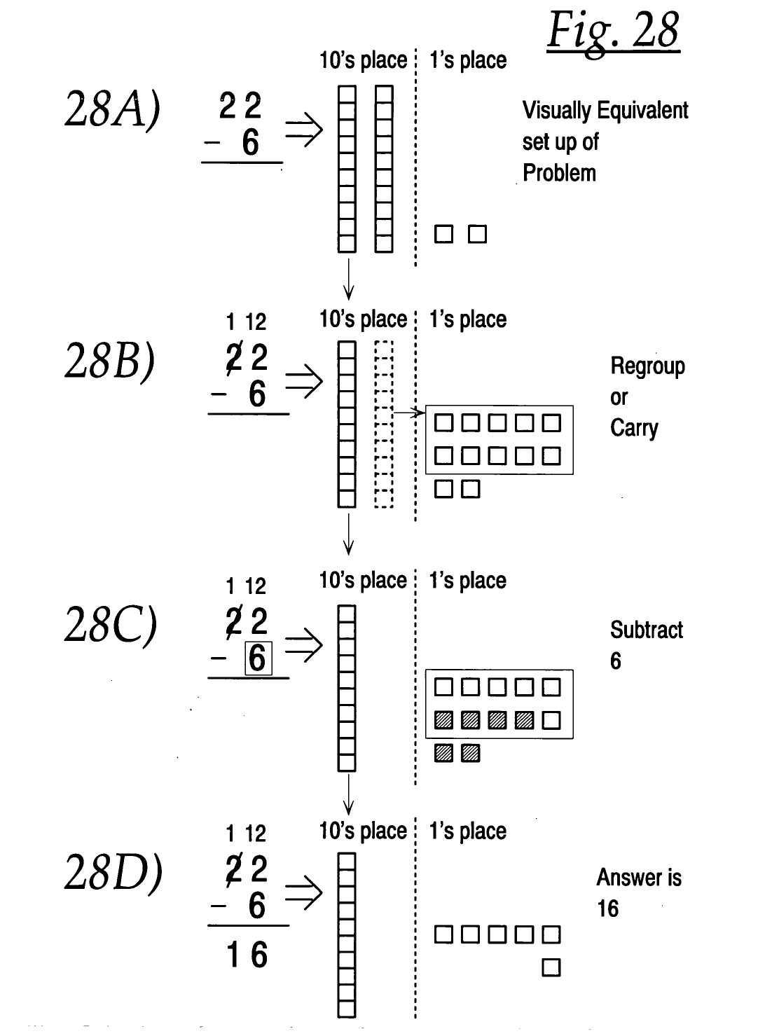

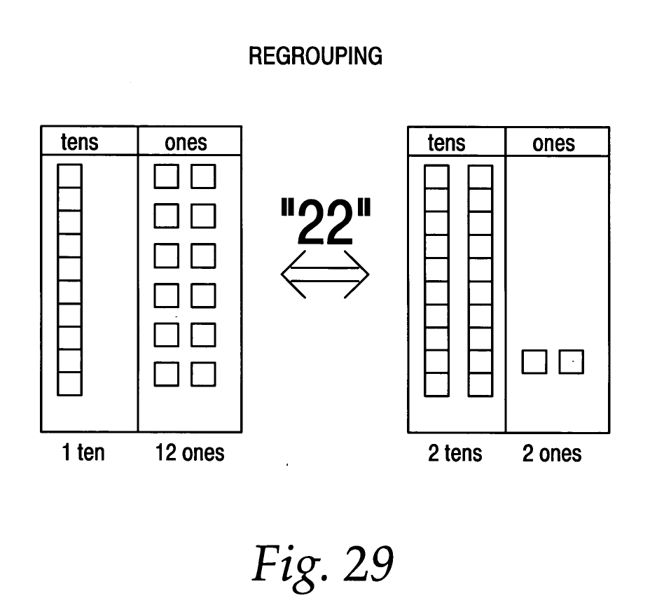

Another property that can be used to delineate between levels of difficulty is regrouping problems. Referring to FIGS. 28 and 29, regrouping is demonstrated. FIG. 29 generally illustrates the concept of regrouping using the number 22. For example, the number 22 can be represented as 20 (2 columns of 10 blocks each) in the ten's place and 2 (2 individual blocks) in the one's place, or alternatively, can be regrouped such that the number is represented with 10 (1 column of 10 blocks) in the ten's place and 12 (12 individual blocks) in the one's place. Blocks are used for illustrative purposes only in order to more clearly convey the concept of regrouping.

Continuing with this concept, FIG. 28 illustrates how regrouping is used in math problems. FIG. 28A shows the problem 22 minus 6 being set up wherein the representation of the number 22 contains 20 (2 columns of 10 blocks each) in the ten's place and 2 (2 individual blocks) in the one's place. FIG. 28B illustrates the concept of regrouping, or carrying, wherein 10 (1 column of 10 blocks) from the ten's place are regrouped to be placed into the one's place so that the operation of 22 minus 6 can be carried out. FIG. 28C illustrates subtracting the 6 (6 individual blocks) from the one's place. FIG. 28D illustrates the end result after the number 6 (6 individual blocks) is subtracted from the one's place leaving the final answer of 16, thereby illustrating the concept of regrouping. Regrouping is also applicable to addition problems. As such, the concept of regrouping can be used to delineate the level of difficulties of problems being presented to students.

FIGS. 24-27 further illustrate the concept of using the properties just described, alone and in combination, to provide different levels of difficulty for different types of problems to be presented to students. Referring to FIG. 24, FIG. 24 illustrates an example of different levels of difficulties of problems that can be presented to a student related to addition problems. For example, level 0 461 has a corresponding property 465 for problems to be presented containing a maximum digits range of 1 for the first operand (numbers from 0-9), a maximum digits range of 1 for the second operand (numbers from 0-9), and wherein the answer to the problems must be less than the number 10. Level 1 462 then removes the limitation of answers being limited to less than the number 10. At level 2 463, the maximum digits range for the first operand is increased to two digits, while the maximum digits range for the second operand is kept at 1 (only numbers from 0-9), and further, no regrouping is required where the first operand is less than the number 20. Moving to level 3 466, level 3 removes the limitation of no regrouping when the first operand is less than the number 20, and substitutes the blanket limitation of no regrouping at all for any of the problems presented at level 3. Next at level 4 464, the blanket limitation of no regrouping is removed so that regrouping problems may be generated. Skipping down to level 11 467, level 11 has a corresponding property for problems that have a two-digit first operand and a one-digit second operand, where the second operand is a negative input or negative operand, but whereby the answer does not generate a negative result. The examples of FIGS. 24-27 showing combinations of properties that can be used to delineate between different levels of difficulties are for illustrative purposes only, and it should be appreciated that there are many variations that can be used to delineate between the levels of difficulty.

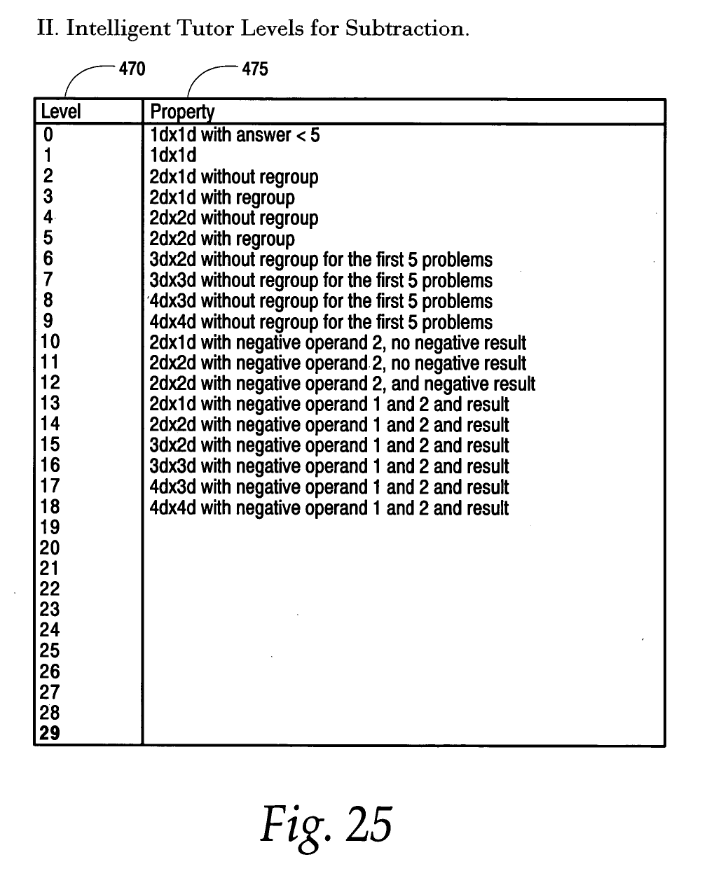

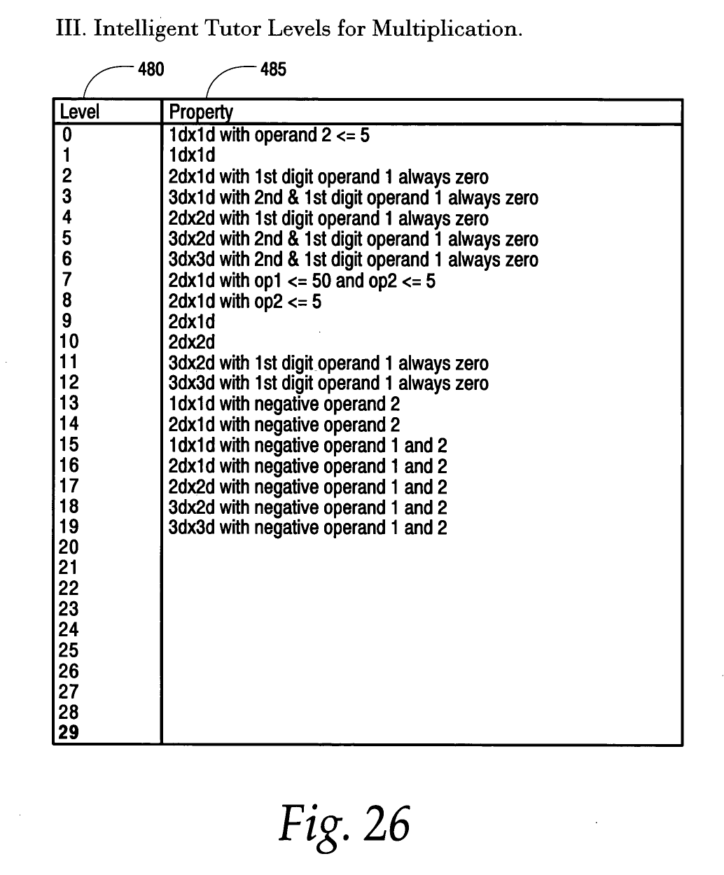

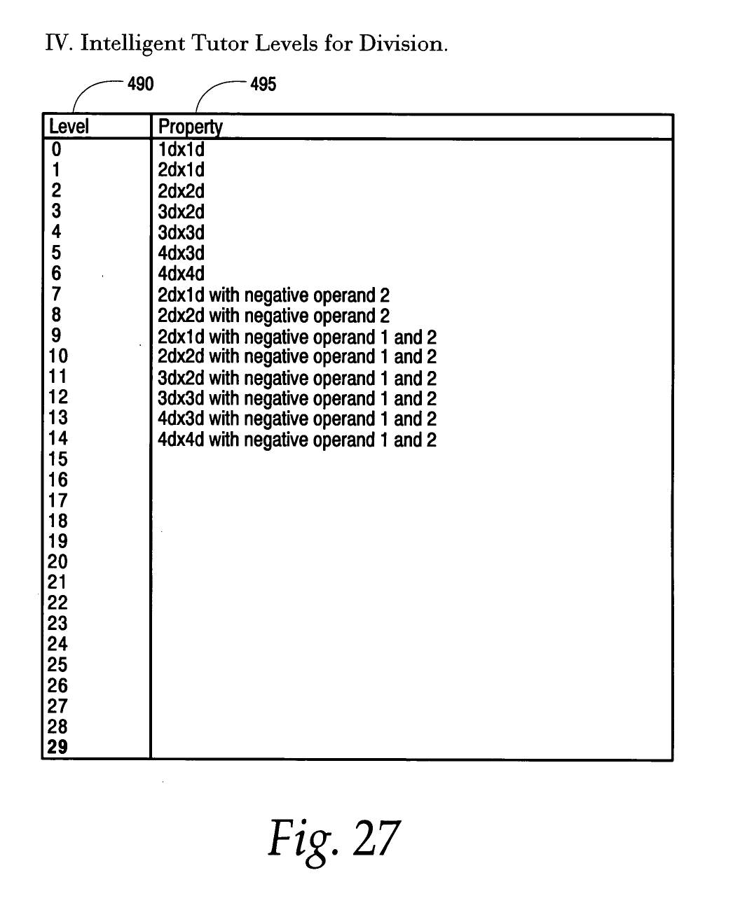

FIG. 25 similarly illustrates an example of the concept of using one or all of the properties to delineate between levels of difficulty for subtraction. FIG. 26 similarly illustrates an example of how the different properties can be used to delineate between levels of difficulties for multiplication. FIG. 27 illustrates an example of how the different properties can be utilized to delineate between levels of difficulty for division problems to be presented to the students. As is understood by one skilled in the art, any and all of the properties described can be used alone or in combination to delineate between levels of difficulties for problems to be presented to the students, however, these properties are not the only factors that can be used to delineate between levels of difficulties. For example, as illustrated in FIG. 24, levels of difficulty can be delineated by limiting the answers to be within certain ranges or values, thereby adding further factors for delineating between levels of difficulties of problems to be presented.

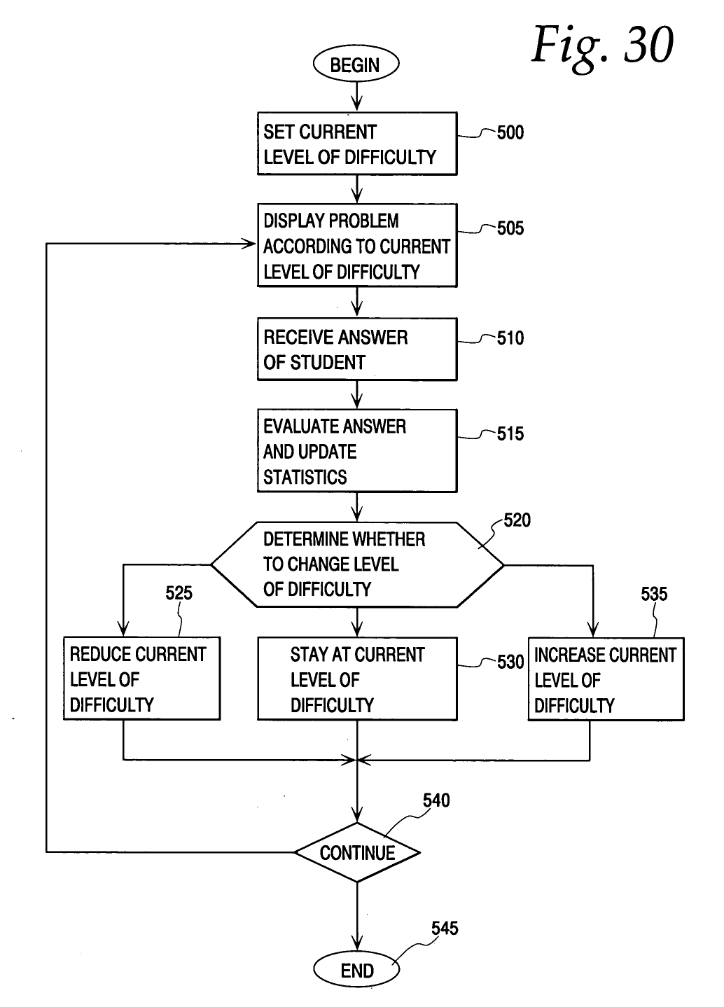

FIG. 30 illustrates generally the method used to control the level of difficulty of the problems being presented to students. Prior to a problem session beginning (not shown), parameters are established that will be utilized for determining, based upon the student's performance, when to change the level of difficulty of problems being presented. Examples of such operating parameters will be further explained herein.

The problem session begins at step 500 by setting a current level of difficulty for problems to be presented to the student. At step 505, problems are then displayed according to the current level of difficulty. Next, at step 510, an answer is received from the student. After the answer is received from the student at step 510, the answer is evaluated and statistics related to the student's performance are maintained and updated at step 515. After the statistics are updated and the answer evaluated in step 515, a determination is made as to whether to change the level of difficulty of problems being presented to the student at step 520. The three steps available following step 520 are step 525 reduce the current level of difficulty, step 530 stay at the current level of difficulty, or step 535 increase the level of difficulty of the problems being presented to the student. At this point, after determining whether to change the level of difficulty and implementing such a change as in steps 525, 530 or 535, the student may at step 540 continue by being presented problems according to the determined level of difficulty, or the student may end the session. If the student elects at step 540 to continue, the session returns to step 505 and repeats. If, however, the student decides not to continue with the problem session at step 540, the session ends at step 545.

Referring back to step 515, the evaluation of the student's answers and updating of the statistics, a number of statistics and data are retained related to the student's performance. Referring to the statistics or data relating to the student's performance, there are a number of categories. As mentioned above, a number of statistics relating to the student's performance must be maintained in order to implement the present system. Of these statistics, some are hard number data and some are derived numbers including, for example, ratios and averaged values. An example of hard number data includes maintaining and updating the total number of incorrect responses by a student at a current level throughout a session. Similarly, the total number of correct responses attempted at a current level is also maintained and updated accordingly. The total number of problems attempted, whether incorrect or correct answers were provided, is also maintained and updated.

An example of derived numbers includes generating an incorrect-to-correct answer ratio, which is also maintained and updated, wherein the ratio consists of the total number of incorrect responses to the total number of correct responses. In addition, the number of consecutive incorrect responses, referred to as the incorrect response streak, is maintained and updated as well. Similarly, a correct response streak is maintained and updated. Additionally, a further ratio referred to as the correct response ratio, is generated, maintained and updated-consisting of the total number of correct responses to the total problems attempted.

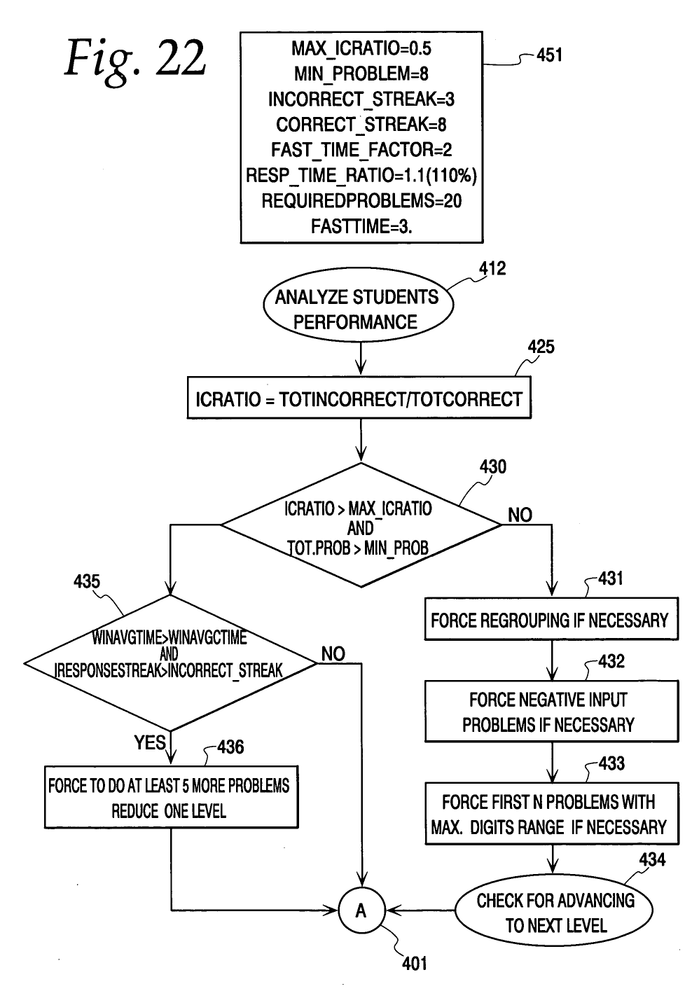

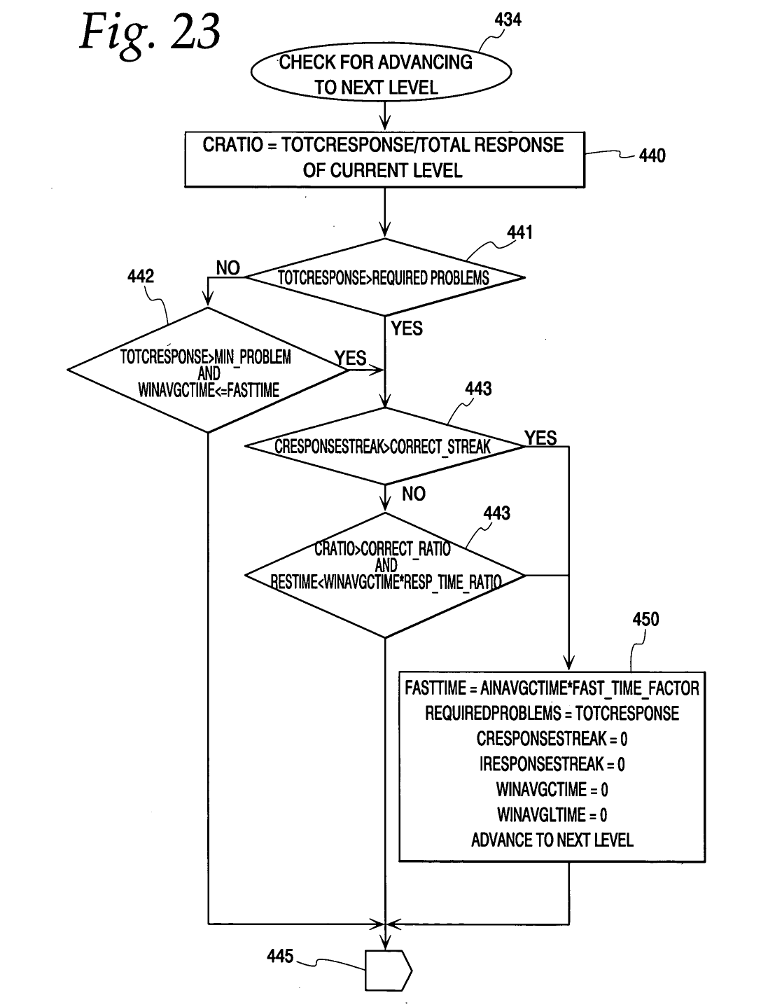

Timing statistics are also recorded, maintained and updated. An example of such is a running average of time associated with incorrect responses and a running average of time associated with correct responses. For example, the average amount of time for an incorrect response is recorded. After a second incorrect response is given, the time associated with the second incorrect response is added to the time associated with the first incorrect response, and the times are averaged to provide a running average of time associated with incorrect responses. The average is recalculated with each subsequent incorrect response. The running average of time associated with correct answers is calculated in the same manner. Another temporal statistic maintained for purposes of determining the appropriate level of difficulty is the accumulated time spent by a student at a current level. Details of how the above-identified statistics are utilized to control the level of difficultly are described below with respect to FIGS. 22 and 23.

In addition to the statistics and data retained relating to the student's performance, there are a number of operating parameters that are maintained relating to the problem session. For example, a maximum parameter value related to the incorrect to correct answer ratio, (the ratio consisting of the total of incorrect responses to the total number of correct responses) is maintained. A parameter value for the minimum number of problems to be attempted at a level is also maintained. Further, a maximum parameter value related to the incorrect response streak, and a minimum parameter value related to the correct response streak are also maintained.

Another parameter maintained is a fast time parameter value by which to multiply with the running average of time associated with correct responses. Similarly, a response time parameter value is maintained by which to multiply with the running average of time associated with correct responses. Also maintained is a parameter value corresponding to the number of required problems that a student must be presented at any current level. Lastly, a maximum parameter value is maintained relating to the correct response ratio based upon the parameters relating to the session and further the statistics maintained, updated and generated relating to the student's performance. As will be further explained below, the session is able to determine whether to change a level of difficulty of problems being presented to a student by comparing the statistics and data to the operating parameters.

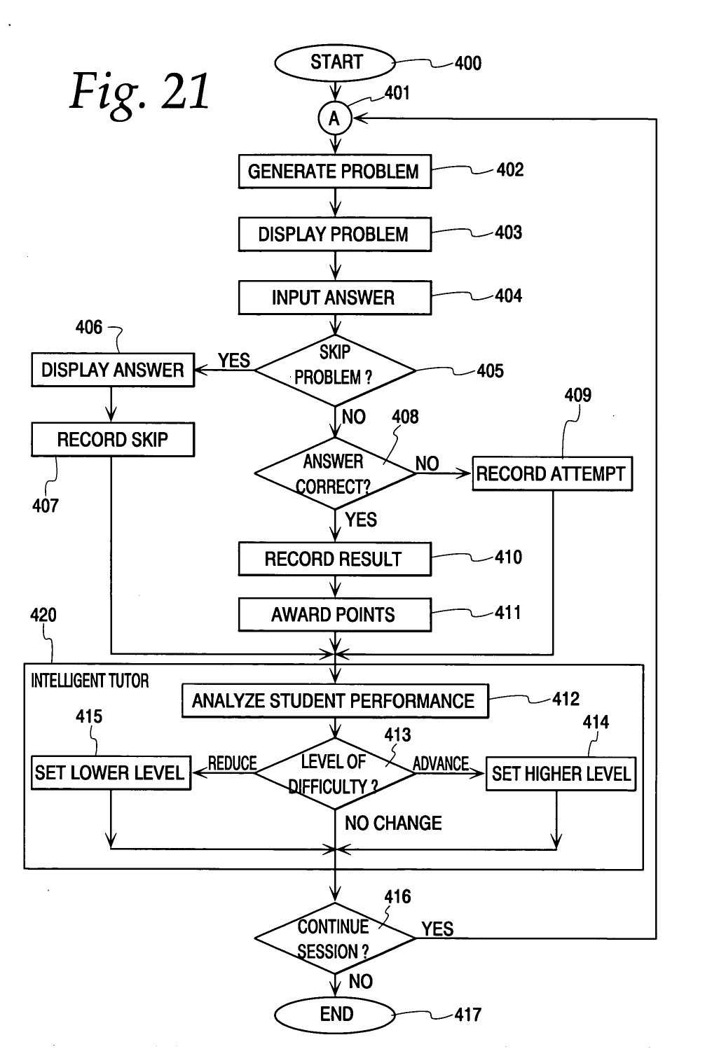

FIGS. 21-23 are example flow charts illustrating a method for analyzing a student's answers and determining whether or not to change the level of difficulty of the problems presented to the student based on the analysis of the student's answers. This analysis includes evaluating the data and statistics collected and retained on the student's performance in light of the operating parameters.

FIG. 21 illustrates an embodiment of the method for determining whether to change the level of difficulty of problems presented to a student. The method starts with a problem session beginning at step 400. At step 401, a determination is made as to what type of problems to generate. If a student had saved an earlier session, the game may generate problems of the same or similar type and level of difficulty as where the student last ended. For illustrative purposes, the types of problems to be generated at step 401 are addition problems with a level of difficulty of 3, for example, in accordance with the embodiment of FIG. 24. At step 402 a problem is generated based upon the determination made at step 401 relating to the type of problems to be generated. Once the problem is generated at step 402, the problem is displayed to the student at step 403. Thus, the game begins by presenting addition problems to the student at a difficulty level of 3 for example.

After the problem has been displayed at step 403, the student enters his or her answer at step 404 to the problem. There are three possibilities regarding the student's answer in step 404: The student may choose to skip the problem if it is too difficult; the student may enter an incorrect answer; or the student may enter the correct response. At step 405, it is determined whether the problem has been skipped or answered. If it is determined at step 405 that the problem was skipped, the correct answer is displayed at step 406, and the fact that the problem was skipped is recorded at step 407. The problem session then advances to determine via the intelligent tutor process 420 whether the level of difficulty should be changed for the next problem to be presented to the student. It should be noted that skipped problems are analyzed in a similar manner as problems incorrectly answered.

If at step 405 it is instead determined that the student provided an answer, a determination is made at step 408 as to whether the student has answered the problem correctly. If the supplied answer is determined to be incorrect, the attempt is recorded at step 409 and the session advances to determine, via the intelligent tutor process 420, whether the level of difficulty should be changed for the next problem to be presented to the student. If, however, it is determined at step 408 that the student answered correctly, the result is recorded at step 410 and points are awarded to the student at step 411.

Once the student has entered the correct response, the student's performance will be analyzed at step 412 to determine whether the level of difficulty should be changed at step 413. There are three possible outcomes to the analysis of step 412: raise the level of difficulty; lower the level of difficulty; or leave the level of difficulty unchanged. If the analysis of the student's performance at step 412 indicates that the level of difficulty should be increased, the level of difficulty is set to the next highest level at step 414. If the analysis indicated that the level of difficulty should be reduced, the difficulty level is set to the next lowest level at step 415. Once the difficulty level has been changed at step 414 or 415, the problem session continues at step 416 where a determination is made as to whether or not to continue with the session. If the analysis at step 412 indicates that there should be no change in the level of difficulty of the problems presented to the student, no change is effected at step 413, and the problem session continues directly to step 416. At step 416, the student can elect whether to continue the problem session or end the session. Although not shown, the student's performance data and data related to the type of problems the student ended the session at can be saved for use with a later session, so as to allow the student to pick up at the point where he/she left off in the previous session.

FIG. 22 is a flow chart illustrating an embodiment of the method of analyzing the student's performance to determine whether or not to change the level of difficulty of the problems being presented to the student, as shown in step 420 of FIG. 21. The analysis begins at step 412, whereafter a ratio is determined at step 425 based upon statistics and data retained related to the student's performance. At step 425 the incorrect-to-correct ratio is determined, where the ratio is established by to the total number of incorrect responses to the total number of correct responses at a current level. At step 430, the incorrect-to-correct ratio is compared to a threshold operating parameter value. Also at step 430, the total number of problems attempted by the student is compared to a threshold operating parameter value related to the minimum number of problems to be attempted at a current level. If the incorrect-to-correct ratio is greater than the parameter value and the total number of problems attempted by the student is greater than the operating parameter value related to the minimum number of problems to be attempted at a current level, the method advances to step 435, wherein further comparisons of the statistics and parameters occur.

At step 435, the running average amount of time associated with incorrect responses is compared to the running average amount of time associated with correct answers. Additionally, the number of consecutive incorrect responses, or the incorrect response streak, is compared to an operating parameter value related to the maximum number of consecutively allowable incorrect answers. If it is determined at step 435 that the running average of time associated with incorrect answers is greater than the running average of time associated with correct answers, and that the incorrect response streak is greater than the operating parameter value it was compared against, the method advances to step 436 and the student is forced to do a fixed number of additional problems before reducing the level of difficulty of the problems to be presented to the student.

Alternatively, referring back to the comparison at step 430, if the incorrect-to-correct ratio is less than the operating parameter related to the incorrect-to-correct answer ratio, or if the total number of problems attempted by the student is less than the parameter value related to the minimum number of problems the student is required to answer at a current level, the method advances to step 431, and the student is forced to answer regrouping problems at step 431, if necessary, negative input problems at step 432, if necessary, and some number of problems with a maximum digits range at step 433, if necessary. The method then continues at step 434 where a determination is made as to whether or not to advance the level of difficulty of the problems being presented to the student.

FIG. 23 illustrates an embodiment of the method for determining whether to advance to the next level of difficulty. The method of step 434 begins at step 440 by determining the correct response ratio, represented by the total number of correct responses to the total number of responses at a current level, as was previously defined. At step 441, the method then compares whether the total number of correct responses by the student at the current level is greater than an operating parameter value related to the required number of problems to be attempted. If the total correct responses by a student at a current level is greater than the operating parameter value of required number of problems at the current level, the method advances to step 443 to further compare the correct number of responses consecutively answered, or the correct response streak, to an operating parameter value related to the correct response streak. If the correct response streak is greater than the operating parameter value, the method advances to step 450 so that certain parameters and statistics are reset to new values, and the level of difficulty of problems presented to the student is advanced.

Alternatively, referring back to comparison at step 441, if the total correct number of responses at a current level is determined to be less than the operating parameter value related to the required number of problems, the method advances to step 442, where the method then compares the total correct number of responses by the student at the current level to an operating parameter value related to the required minimum number of problems to be attempted at a current level, and also compares the running average of time associated with correct responses to the running average of time associated with correct answers multiplied by the fast time parameter value. If the total correct responses by the student at the current level is greater than the operating parameter value related to the required minimum number of problems to be attempted at a current level, and the running average of time associated with correct answers is less than the running average of time associated with correct answers multiplied by the fast time parameter value, the method advances to step 443 where a further comparison is made. If however, the total correct responses by the student at the current level is less than the operating parameter value related to the required minimum number of problems to be attempted at a current level, or the running average amount of time associated with correct answers is greater than the running average of time associated with correct answers multiplied by the fast time parameter value, the method advances to step 445, where it presents the student with additional problems at the current level of difficulty.

Referring to the comparison at step 443, if the correct response streak is less than the operating parameter value related to the correct response streak, the method advances to step 444, wherein the correct response ratio is compared to an operating parameter value related to the correct response ratio, and wherein the accumulated amount of time spent by the student at the current level is compared to the running average of time associated with correct answers multiplied by an operating parameter value related to the accumulated time. If the correct response ratio is greater than the operating parameter value related to the correct response ratio, and the accumulated time is less than the running average of time associated with correct responses multiplied by the operating parameter value related to the accumulated time, the method advances to step 450, wherein certain parameters and statistics may be reset to new values and the problems presented to the student advanced to the next level of difficulty. If however, the correct response ratio is less than the operating parameter value related to the correct response ratio, or the accumulated time is greater than the running average of time associated with correct answers multiplied by the operating parameter value related to the accumulated time, the method advances to step 445 wherein the student is presented with further problems at the current level.

The method and system embodiments described above allow students to learn at a pace that is manageable for each individual student, while still challenging the student to excel in educational skills. By controlling the level of difficulty of educational problems presented to a student during the game session, the student is challenged to learn, but not discouraged by continually encountering problems that are too difficult for the student. To this end, the operating parameters and statistics, along with the methods disclosed herein, provide the information necessary to control and implement the multitude of available changes to the level of difficulty of problems presented to the students.

It should be understood that various changes and modifications to the presently preferred embodiments described herein will be apparent to those skilled in the art. Such changes and modifications can be made without departing from the spirit and scope of the present invention as claimed and without diminishing its intended advantages. It is therefore intended that such changes and modifications be covered by the appended claims.

1. A method of controlling a game for improving a student's math performance, the method comprising:
presenting a plurality of math problems to a student;
receiving responses including a response from the student for each problem;
maintaining statistics regarding the student's responses;
determining whether to alter a characteristic of an additional math problem to be presented to the student based on the statistics; and
presenting the additional math problem incorporating the altered characteristic to the student.

2. The method of claim 1 wherein the student's responses are selected from the group comprising: skipping a math problem; displaying a solution; and entering a solution.

3. The method of claim 1 wherein the statistics comprise a total number of problems attempted, and wherein determining whether to alter a characteristic of the additional math problem comprises comparing the total number of problems attempted to an operating parameter value.

4. The method of claim 3 wherein the characteristic of the additional math problem is altered to force a regrouping of the plurality of math problems.

5. The method of claim 3 wherein the characteristic of the additional math problem is altered to force negative input problems.

6. The method of claim 3 wherein the characteristic of the additional math problem is altered to force a predetermined number of problems with a maximum digits range for operands.

7. The method of claim 1 wherein maintaining statistics comprises calculating a total number of problems attempted.

8. The method of claim 1 wherein the statistics comprise a total number of problems answered correctly.

9. The method of claim 1 wherein the statistics comprise a total number of problems answered incorrectly.

10. The method of claim 1 wherein the statistics comprise a ratio of a total number of incorrect answers to a total number correct answers.

11. The method of claim 10 wherein determining whether to alter a characteristic of the additional math problem comprises comparing the ratio to an operating parameter value, and wherein determining whether to alter a characteristic of the additional math problem further comprises altering the characteristic of the additional math problem when the ratio is greater than the operating parameter value.

12. The method of claim 1 wherein maintaining statistics comprises calculating an average of student elapsed response times.

13. The method of claim 12 wherein the average comprises a running average of response times from a number of most recent problems presented to the student.

14. The method of claim 12 wherein the average comprises a running average of correct response times.

15. The method of claim 12 wherein the average comprises a running average of incorrect response times.

16. The method of claim 1 wherein the statistics comprise a total of a number of problems consecutively answered incorrectly.

17. The method of claim 1 wherein the statistics comprise a total of a number of problems consecutively answered correctly.

18. The method of claim 1 wherein determining whether to alter a characteristic of the additional math problem comprises comparing a running average of incorrect response times to a running average of correct response times.

19. The method of claim 1 wherein determining whether to alter a characteristic of the additional math problem comprises comparing a total of a number of problems consecutively answered incorrectly to an operating parameter value.

20. The method of claim 1 wherein the characteristic of the additional math problem is altered to force additional problems at a current level.

21. The method of claim 1 wherein the characteristic of the additional math problem is altered to change a level of difficulty of the additional math problem being presented.

22. The method of claim 1 wherein the statistics comprise a total number of problems attempted at a current level.

23. The method of claim 22 wherein the statistics comprise a ratio of a total number of correct responses at a current level to the total number of problems attempted at the current level, and wherein determining whether to alter a characteristic of the additional math problem comprises comparing the ratio to an operating parameter value.

24. The method of claim 1 wherein maintaining statistics comprises calculating a total number of problems attempted at a current level.

25. The method of claim 24 wherein maintaining statistics comprises calculating a ratio of a total number of correct responses at a current level to the total number of problems attempted at the current level.

26. The method of claim 1 wherein determining whether to alter a characteristic of the additional math problem comprises comparing a total number of correct responses at a current level to an operating parameter value.

27. The method of claim 1 wherein determining whether to alter a characteristic of the additional math problem comprises comparing a running average of student correct response times to a running average of correct response times multiplied by a fast time parameter value.

28. The method of claim 1 wherein the characteristic of the additional math problem is altered to force additional problems at a current level.

29. The method of claim 1 wherein determining whether to alter a characteristic of the additional math problem comprises comparing a total number of correctly consecutively answered problems to an operating parameter value.

30. The method of claim 1 wherein the statistics comprise an accumulated time that the student has been playing the game.

31. The method of claim 30 wherein determining whether to alter a characteristic of the additional math problem comprises comparing a running average of correct response times multiplied by an operating parameter value to the accumulated time that the student has been playing the game.

32. The method of claim 1 wherein maintaining statistics comprises calculating an accumulated time that the student has been playing the game.

33. The method of claim 1 wherein the characteristics of the additional math problem is altered to change an operator of the additional math problem.

34. The method of claim 33 wherein the operator is selected from the group comprising addition, subtraction, multiplication and division.

35. The method of claim 1 wherein the characteristic of the additional math problem is altered to change a number of digits of any operand of the additional math problem.

36. The method of claim 1 wherein the characteristics of the additional math problems is altered to change a number of digits of a first operand and a second operand of the additional math problem.

37. A method of controlling a level of difficulty of problems presented to a student, the method comprising:
defining a plurality of difficulty levels;
defining a characteristic of problems associated with each difficulty level;
presenting a problem having a characteristic associated with a first difficulty level to the student;
receiving a response to the problem from the student;
retaining data about the response to the problem;
determining whether to present problems having a characteristic associated with a second difficulty level based on the retained data.

38. The method of claim 37 wherein the retained data comprises a total number of problems attempted, a total number of problems answered correctly, a total number of problems answered incorrectly, and a ratio of the total number of incorrect answers to the total number of correct answers.

39. The method of claim 38 wherein determining whether to present problems having a characteristic associated with a second difficulty level based on the retained data comprises comparing the ratio to an operating parameter value, and presenting problems having the characteristic associated with the second difficulty level when the ratio is greater than the operating parameter value.

40. The method of claim 37 wherein presenting problems having a characteristic associated with a second difficulty level based on the retained data comprises comparing a total number of problems attempted to an operating parameter value, and wherein determining whether to present problems having a characteristic associated with a second difficulty level based on the retained data comprises presenting problems having the characteristic associated with the second difficulty level when the total number of problems attempted is greater than the operating parameter value.

41. The method of claim 40 wherein the characteristic associated with a second difficulty level is selected from the group consisting of regrouping problems, negative input problems, and maximum digits range for operands.

42. The method of claim 37 wherein retaining data further comprises calculating an average of student elapsed response times, and wherein the average is selected from the group consisting of a running average of student response times from a number of recent problems presented to the student, a running average of student correct response times, and a running average of student incorrect response times.

43. The method of claim 37 wherein the retained data is selected from the group consisting of a total of a number of problems consecutively answered incorrectly, and a total of a number of problems consecutively answered correctly.

44. The method of claim 37 wherein retaining data is selected from the group consisting of calculating a total of a number of problems consecutively answered incorrectly, and calculating a total of a number of problems consecutively answered correctly.

45. The method of claim 37 wherein determining whether to present problems having a characteristic associated with a second difficulty level based on the retained data comprises comparing a running average of student incorrect response times to a running average of student correct response times.

46. The method of claim 37 wherein determining whether to present problems having a characteristic associated with a second difficulty level based on the retained data comprises comparing a total number of problems consecutively answered incorrectly to an operating parameter value.

47. The method of claim 37 wherein the characteristic associated with a second difficulty level is selected from the group consisting of additional problems at a current level, and changing a level of difficulty of additional problems being presented.

48. The method of claim 37 wherein the retained data comprises a total number of problems attempted at a current level, and further comprises a ratio of a total number of correct responses at a current level to the total number of problems attempted at the current level.

49. The method of claim 37 wherein retaining data comprises calculating a total number of problems attempted at a current level, and wherein retaining data further comprises calculating a ratio of a total number of correct responses at a current level to the total number of problems attempted at the current level.

50. The method of claim 37 wherein determining whether to present problems having a characteristic associated with a second difficulty level based on the retained data comprises comparing a total number of correct responses at a current level to an operating parameter value.

51. The method of claim 37 wherein determining whether to present problems having a characteristic associated with a second difficulty level based on the retained data comprises comparing a running average of student correct response times to the running average of student correct response times multiplied by a fast time parameter value.

52. The method of claim 37 wherein determining whether to present problems having a characteristic associated with a second difficulty level based on the retained data comprises comparing a total number of correctly consecutively answered problems to an operating parameter value.

53. The method of claim 37 wherein the retained data comprises an accumulated time that the student has been playing a game and wherein determining whether to present problems having a characteristic associated with a second difficulty level based on the retained data comprises multiplying a running average of student correct response times by an operating parameter value to produce a result, and comparing the result to the accumulated time that the student has been playing the game.

54. The method of claim 37 wherein retaining data comprises calculating an accumulated time that the student has been playing a game.

55. The method of claim 37 wherein the characteristic associated with the second difficulty level comprises an operator of the problem, wherein the operator is selected from the group comprising addition, subtraction, multiplication and division.

56. The method of claim 37 wherein the characteristic associated with the second difficulty level comprises a number of digits of an operand of an additional problem.

57. A system for controlling a level of difficulty of problems presented to a student, the system comprising:
a display for presenting the problems to the student;
an input allowing the student to provide responses to the problems presented;
a memory capable of storing the student responses and data related to the student responses; and
a controller for controlling the level of difficulty of problems presented, the controller being structured to evaluate the student responses and to generate the data related to the student responses, wherein the controller, based upon the student responses and the data related to the student responses, changes the level of difficulty of the problems being presented to the student, wherein the data is selected from the group consisting of a total number of problems attempted, a total number of problems answered correctly, an accumulated time that the student has been playing the game, a total number of problems answered incorrectly, a ratio of a total number of incorrect answers to a total number correct answers, a total of a number of problems consecutively answered incorrectly, a total of a number of problems consecutively answered correctly, and a total number of problems attempted at a current level.

58. The system of claim 57, wherein the data comprises a ratio of a total number of correct responses at the current level to the total number of problems attempted at the current level.

59. A computer readable medium storing instructions structured to cause a computing device to:
present a plurality of problems to a user;
receive at least one response from the user for each problem, wherein the response includes at least one of skipping a problem, displaying a solution, and entering the solution;
maintain statistics regarding the at least one response, wherein the statistics comprise an accumulated time that the student has been playing a game, a total number of problems attempted, a total number of problems answered correctly, a total number of problems answered incorrectly, a ratio of a total number of incorrect answers to a total number correct answers, a total of a number of problems consecutively answered incorrectly, a total of a number of problems consecutively answered correctly, a total number of problems attempted at a current level, and a ratio of a total number of correct responses at the current level to the total number of problems attempted at the current level;
determine whether to alter a characteristic of an additional problem presented to the user based on the statistics, wherein the characteristic is selected from a group comprising increasing a level of difficulty, decreasing the level of difficulty, and maintaining the level of difficulty; and
present the additional problem incorporating the altered characteristic to the user.
